(19) United States
(12) Patent Application Publication
(10) Pub. No.: US 2024/0244481 A1
(43) Pub. Date: Jul. 18, 2024

(54) COMMUNICATION METHODS AND MULTILINK APPARATUS

(71) Applicant: CANON KABUSHIKI KAISHA, Tokyo (JP)

(72) Inventors: Pascal VIGER, JANZE (FR); Romain GUIGNARD, RENNES (FR); Mickael LORGEOUX, RENNES (FR)

(21) Appl. No.: 18/559,904

(22) PCT Filed: May 2, 2022
(86) PCT No.: PCT/EP2022/061657

§ 371 Date: Nov. 9, 2023

(30) Foreign Application Priority Data
May 10, 2021 (GB) 2106654.3
Jul. 30, 2021 (GB) 2111013.5

(51) Int. Cl. H04W 28/02; H04L 1/1607; H04W 72/12

(52) U.S. Cl. CPC H04W 28/0278; H04L 1/1614; H04W 72/12

(57) ABSTRACT

The present invention concerns a communication method in a wireless communication network comprising an access point, AP, multi-link device, MLD, having multiple affiliated access points, and at least one station MLD, having multiple affiliated stations, both station MLD and AP MLD being able to exchange data using one or more links, the method comprising at the station MLD: transmitting to the AP MLD a multi-link buffer status report, ML-BSR, comprising an indication relating to an amount of data to be transmitted, for the AP MLD to schedule a resource to the station MLD to transmit data; and wherein the ML-BSR further comprises an indication relating to a link on which the station MLD expects to be scheduled for the transmission of the amount of data to be transmitted.

### CROSS-REFERENCE TO RELATED APPLICATIONS

This application is a National Phase entry of PCT Application No. PCT/EP2022/061657, filed on May 2, 2022 and titled “COMMUNICATION METHODS AND MULTILINK APPARATUS,” which claims the benefit under 35 U.S.C. § 119(a)-(d) of United Kingdom Patent Application No. 2111013.5, filed on Jul. 30, 2021 and titled “COMMUNICATION METHODS AND MULTILINK APPARATUS,” and United Kingdom Patent Application No. 2106654.3, filed on May 10, 2021 and titled “COMMUNICATION METHODS AND MULTILINK APPARATUS.” The above cited patent applications are incorporated herein by reference in their entireties.

### FIELD OF THE INVENTION

The present invention generally relates to wireless communications and more specifically to Multi-Link (ML) communication.

### BACKGROUND OF INVENTION

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D0.4 version (March 2021) introduces the Multi-link (ML) operation (MLO). MLO improves data throughput by allowing communications between stations over multiple concurrent and non-contiguous communication links.

Multi-Link Operation (MLO) enables a non-AP (access point) MLD (ML device) to register with an AP MLD, i.e., to discover, authenticate, associate and set up multiple links with the AP MLD. Each link enables channel access and frame exchanges between the non-AP MLD and the AP MLD based on supported capabilities exchanged during association.

A MLD is a logical entity that has more than one affiliated station (AP or non-AP) and has a single medium access control (MAC) service access point (SAP) to logical link control (LLC), which includes one MAC data service. An AP MLD is thus made of multiple affiliated APs whereas a non-AP MLD is made of multiple affiliated non-AP stations. The affiliated stations in both AP MLD and non-AP-MLD can use 802.11 mechanisms to communicate with affiliated stations of another MLD over each of the multiple communication links that are set up.

During ML discovery, a non-AP MLD discovers the various wireless links available by the AP MLD through its various affiliated APs. The non-AP MLD builds a set of candidate setup links associating affiliated APs with affiliated non-AP stations, from the discovered links (affiliated APs). During ML setup, the non-AP MLD, in collaboration with the AP MLD, determines a set of candidate setup links to be used for data exchange between the non-AP MLD and the AP MLD.

In trigger-based transmissions, the AP MLD gives an uplink transmission opportunity to one of the associated stations, which is granted by in a trigger frame on a given link. However, when choosing the link to emit in a trigger frame, sometimes the AP MLD may not be aware of disturbances on some links for some particular non-AP MLD. Thus, when choosing a link, the AP MLD does not offer any guarantee regarding the latency, reliability or jitter of the transmission, which mainly depends on radio reception at the non-AP MLD side.

Therefore, more efficient multilink communication mechanisms are desired, particularly in view of improving the overall data throughput in a network while ensuring a low latency.

### SUMMARY OF THE INVENTION

The inventors have found various alternative solutions to this particular problem.

Embodiments of the invention provide a communication method in a wireless communication network comprising an access point, AP, multi-link device, MLD, having multiple affiliated access points, and a station MLD, having multiple affiliated stations, both station MLD and AP MLD being able to exchange data using one or more links,
the method comprising at the station MLD:
transmitting to the AP MLD a multi-link buffer status report, ML-BSR, comprising an indication relating to an amount of data to be transmitted, for the AP MLD to schedule a resource to the station MLD to transmit data; and
   wherein the ML-BSR further comprises an indication relating to a link on which the station MLD expects to be scheduled for the transmission of the amount of data to be transmitted.

Correspondingly, a station multi-link device, MLD, having multiple affiliated stations in a wireless communication network comprising an access point, AP, multi-link device, MLD, having multiple affiliated access points, both station MLD and AP MLD being able to exchange data using one or more links, and
the station MLD comprising a microprocessor configured to perform:
transmitting to the AP MLD a multi-link buffer status report, ML-BSR, comprising an indication relating to an amount of data to be transmitted, for the AP MLD to schedule a resource to the station MLD to transmit data; and
wherein the ML-BSR further comprises an indication relating to a link on which the station MLD expects to be scheduled for the transmission of the amount of data to be transmitted

Thanks to such ML-BSR, the AP MLD is then in possession of an additional information, regarding the link considered by the non-AP, as being the more adapted for a subsequent scheduling for an UL transmission, either in single-user or multi-user mode.

Therefore, the AP MLD transmits to the non-AP MLD scheduling information regarding the transmission of the reported data in the ML-BSR. Scheduling information may take or not into consideration the indication of the ML-BSR regarding to the link on which the non-AP MLD expects to be scheduled.

Optional features of these embodiments of the invention are defined in the appended claims. Some of these features are explained here below with reference to a method, while they can be transposed into device features.

In embodiments, the method may further comprise:
receiving from the AP MLD scheduling information for the transmission of the amount of data to be transmitted; and
transmitting the amount of data to be transmitted according to the received scheduling information.

In embodiments, the ML-BSR may further comprise an indication relating to a type of data which is associated with the amount of data to be transmitted.

In embodiments, the ML-BSR may comprise a first field comprising an indication relating to the amount of data in the buffer of the non-AP MLD, a second field comprising an indication relating to the link on which the station MLD expects to be scheduled for the transmission of the amount of data to be transmitted, and a third field comprising an indication relating to the type of data.

In embodiments, the type of data may be either indicative of a type of traffic category or indicative of a traffic stream.

In embodiments, the ML-BSR may further comprise an indication relating to a time limit for transmitting the amount of data indicated in the ML-BSR.

In embodiments, the ML-BSR may be transmitted within a MAC data frame.

In embodiments, the first and second fields may be subfields comprised in a QoS control field in a header of the MAC data frame, and the third field may be a subfield comprised in a High Throughput (HT) or an Extremely High Throughput (EHT) or a High efficiency (HE) control field in the header of the MAC data frame.

In embodiments, the first, second and third fields may be subfields comprised in a High Throughput (HT) or an Extremely High Throughput (EHT) or a High efficiency (HE) control field in a header of the MAC data frame.

In embodiments, the method may comprise at the station MLD:
sending a link bitmap indicating one or more links for which an amount of data to be transmitted is provided.

A bit corresponding to a given link in the link bitmap may be the indication in the meaning of the invention. Hence, such bit plus the amount of buffered data (to be subsequently provided for the given link) form together the ML-BSR. In variants, the link bitmap may only announce that subsequent ML-BSRs (i.e., including the indication) are about to be provided for the links signalled in the bitmap.

In embodiments, the link bitmap and the amount or amounts of data to be transmitted which are provided for the one or more links may be provided within separate subframes of an aggregate MAC data frame (Aggregate MAC Protocol Data Unit (A-MPDU)).

In embodiments, the link bitmap may include an Assisted AP Link ID Bitmap as defined in 802.11be D1.0 (section 9.2.4.6a).

In embodiments, the link bitmap may be additional to an Assisted AP Link ID Bitmap as defined in 802.11be D1.0 (section 9.2.4.6a).

In embodiments, the link bitmap may select a subset of links indicated in the Assisted AP Link ID Bitmap.

In embodiments, multiple amounts of data to be transmitted for multiple links may be provided in 802.11ax BSR control fields or QoS Control fields of one or more MAC frame headers, in the same order over time as the link indications in the link bitmap.

In embodiments, the amount or amounts of data to be transmitted for the one or more links may be provided in one or more ML-BSR subsequent to the link bitmap.

In embodiments, the transmission of the ML-BSR may be in response to a receiving of a request to provide information relating to an amount of data to be transmitted by the station MLD for a given type of data and information relating to a link on which the station MLD expects to be scheduled for the transmission of the amount of data to be transmitted,
wherein the request is from the AP MLD.

In embodiments, the ML-BSR may be transmitted using a link different from the link indicated within the ML-BSR.

Embodiments of the invention further provide a communication method in a wireless communication network comprising an access point, AP, multi-link device, MLD, having multiple affiliated access points and at least one station MLD, having multiple affiliated stations, both station MLD and AP MLD being able to exchange data using one or more links,
the method comprising at the AP MLD:
receiving from the station MLD, a multi-link buffer status report, ML-BSR, comprising an indication relating to an amount of data to be transmitted, for determining scheduling resource for the station MLD to transmit data wherein the ML-BSR further comprises an indication relating to a link on which the station MLD expects to be scheduled for a transmission of the amount of data to be transmitted.

Correspondingly, an access point, AP, multi-link device, MLD, having multiple affiliated access points in a wireless communication network comprising at least one station MLD, having multiple affiliated stations, both station MLD and AP MLD being able to exchange data using one or more links, and
the AP MLD comprising a microprocessor configured to perform:
receiving from the station MLD, a multi-link buffer status report, ML-BSR, comprising an indication relating to an amount of data to be transmitted, for determining scheduling resource for the station MLD to transmit data wherein the ML-BSR further comprises an indication relating to a link on which the station MLD expects to be scheduled for a transmission of the amount of data to be transmitted.

Optional features of these embodiments of the invention are defined in the appended claims. Some of these features are explained here below with reference to a method, while they can be transposed into device features.

In some embodiments, the method may further comprise:
according to the received ML-BSR, determining scheduling information to be used by the at least one station MLD for the transmission of the amount of data to be transmitted; and
transmitting to the station MLD, within a subsequent frame, the determined scheduling information.

In embodiments, the scheduling information may comprise a resource allocation.

In embodiments, the resource allocation may be on the link on which the station MLD expects to be scheduled for the transmission of the amount of data to be transmitted.

In embodiments, the subsequent frame may comprise a ML-BSR, indicating the determined resource allocation and the amount of data to be sent on the allocated resource.

In embodiments, the method may comprise:
receiving a link bitmap indicating one or more links for which an amount of data to be transmitted is provided.

In embodiments, the link bitmap and the amount or amounts of data to be transmitted which are provided for the one or more links may be received within separated subframes of an aggregate MAC data frame.

In embodiments, the amount or amounts of data to be transmitted for the one or more links may be received in one or more ML-BSR subsequently to the receiving of the link bitmap.

In embodiments, the receiving may be in response to a sending of a request to provide information relating to the amount of data to be transmitted by the station MLD and relating to the link on which the station MLD expects to be scheduled for the transmission of the amount of data to be transmitted.

In embodiments, the request may be a Multi-Link Buffer Status Report Poll, ML-BSRP, frame.

In embodiments, the ML-BSRP frame may comprise an indication relating to a type of data to be considered by the station MLD for building the ML-BSR and an indication relating to links among the one or more links that may be chosen by the station MLD to be the link on which the station MLD expects to be scheduled for the transmission of the amount of data to be transmitted.

According to another aspect of the invention there is provided a communication method in a wireless communication network comprising an access point, AP, multi-link device, MLD, having multiple affiliated access points and at least one station MLD, having multiple affiliated stations, both station MLD and AP MLD being able to exchange data using one or more links,
the method comprising at the AP MLD:
transmitting to the station MLD a multi-link buffer status report, ML-BSR, comprising an indication relating to a resource allocation on a determined link to be used for a subsequent uplink transmission, and an indication relating to an amount of data that the allocated resource is capable to convey.

Such scheme enables packets to be sent to be prepared in advance by the affiliated station of the non-AP MLD associated with the link indicated by the AP MLD. Knowing in advance the link to be used for the upcoming scheduled transmission enables the preparing of the packet at the relevant low MAC layer associated to the link to be used. Therefore, such method enables to reduce the latency of the UL transmissions.

Correspondingly, an access point, AP, multi-link device, MLD, having multiple affiliated access points, in a wireless communication network comprising at least one station MLD, having multiple affiliated stations, both station MLD and AP MLD being able to exchange data using one or more links, and
the AP MLD comprising a microprocessor configured to perform:
transmitting to the station MLD a multi-link buffer status report, ML-BSR, comprising an indication relating to a resource allocation on a determined link to be used for a subsequent uplink transmission, and an indication relating to an amount of data that the allocated resource is capable to convey.

In embodiments, the ML-BSR may be comprised within a downlink MAC frame.

In embodiments related to the various aspects of the invention, the station MLD may be a non-AP MLD, whose affiliated stations are non-AP stations.

In embodiments related to the various aspects of the invention, the station MLD may be an AP MLD, whose affiliated stations are AP stations.

In embodiments related to the various aspects of the invention, the station MLD may be a non-AP MLD, whose affiliated stations are non-AP stations, and wherein the AP MLD may be a software AP supporting Wi-Fi Direct protocol.

The invention further provides a frame to be sent by a station multi-link device, MLD, having multiple affiliated stations to an access point multi-link device, MLD, having multiple affiliated access points of a wireless communication network, the frame comprising an indication relating to an amount of data awaiting to be sent by the station MLD,
wherein the frame further comprises an indication relating to a link on which the station MLD expects to be scheduled for the trigger-based uplink transmission.

In some embodiments, the frame may comprise a multi-link buffer status report, ML-BSR, specifying, for a given type of data, an amount of data in a buffer of station MLD that the station MLD requests to send on the indicated link.

In some embodiments, the frame may be a MAC data frame.

In some embodiments, the frame may comprise a link bitmap indicating one or more links for which an amount of data to be transmitted is provided.

In some embodiments, the frame may be an aggregate MAC data frame comprising in separate subframes respectively the link bitmap and the amount or amounts of data to be transmitted which are provided for the one or more links.

In some embodiments, the link bitmap may include an Assisted AP Link ID Bitmap as defined in 802.11be D1.0 (section 9.2.4.6a).

In some embodiments, in addition to the link bitmap, the frame may comprise an Assisted AP Link ID Bitmap as defined in 802.11be D1.0 (section 9.2.4.6a).

In some embodiments, the link bitmap may select a subset of links indicated in the Assisted AP Link ID Bitmap.

In some embodiments, the frame may comprise multiple 802.11ax BSR control fields or QoS Control fields within one or more MAC frame headers in which multiple amounts of data to be transmitted for multiple links are provided, in the same order over time as link indications in the link bitmap.

In some embodiments, the frame further comprises one or more ML-BSR subsequent to the link bitmap, indicating the amount or amounts of data to be transmitted for the one or more links.

Besides, the invention provides a frame to be sent by an access point multi-link device, MLD, having multiple affiliated access points of a wireless communication network to at least one station MLD, having multiple affiliated stations, the frame comprising a multi-link buffer report status, ML-BSR, indicating a determined link to be used for a subsequent uplink transmission and the amount of data to be sent during the subsequent uplink transmission.

In some embodiments, the ML-BSR may comprise an indication relating to a resource allocation on the determined link and an indication relating to the amount of data the resource allocation is capable to convey.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g., a microwave or RF signal.

### BRIEF DESCRIPTION OF THE DRAWINGS

Embodiments of the invention will now be described, by way of example only, and with reference to the following drawings in which:

FIG. 1 illustrates an example of a multi-link arrangement in accordance with 802.11be;

FIG. 2 illustrates an example of a reference model of a 802.11be multi-link device;

FIG. 3 illustrates Multi-Link Operations between an originator ML device and a recipient ML device.

FIG. 4 illustrates an example of a MAC data frame comprising a Buffer Status Report Control Field (BSR Control field) according to 802.11ax;

FIG. 5 illustrates a generic of a format of a multi-link buffer status report (ML-BSR) dedicated to multi-link devices according to the invention;

FIG. 6a illustrates a ML-BSR format that is based on the BSR Control field according to 802.11ax as illustrated in FIG. 5;

FIG. 6b illustrates a ML-BSR format that is based on the QoS Control field according to 802.11ax as illustrated in FIG. 5;

FIG. 6c illustrates a generic format of a ML-BSR dedicated to multi-link devices including a timing indication;

FIG. 7 illustrates using a flowchart, the ML-BSR operation by a non-AP ML station according to embodiments of the invention;

FIG. 8a illustrates, using a flowchart, embodiments of the invention implemented at a scheduling ML AP soliciting multi-link data reports (ML-BSR) according to embodiments of the invention;

FIG. 8b illustrates using a flowchart, embodiments of the invention implemented at a scheduling station (AP) when it has received multi-link data reports (ML-BSR) and further intends to schedule scheduled stations (non-AP) according to embodiments of the invention;

FIG. 8c illustrates some field of a Multi-link Buffer Status Report Poll (ML-BSRP) used by the AP for soliciting multi-link data reports (ML-BSR);

FIG. 9 illustrates an exemplary timeline of a communication exchange according to embodiments of present invention;

FIG. 10 schematically illustrates a communication device, either a ML non-AP device (embedding a plurality of non-AP stations) or a ML AP device (embedding a plurality of APs), of a radio network, configured to implement at least one embodiment of the present invention;

FIG. 11 schematically illustrates the architecture of the communication device, using a block diagram, adapted to carry out, at least partially, the invention; and

FIG. 12 illustrates several embodiments wherein a global ML-BSR report including respectively individual ML-BSR or individual legacy BSR, is provided based on a Link Bitmap.

### DETAILED DESCRIPTION OF THE INVENTION

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e., wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

Note that it is not excluded that an apparatus may act as an AP of one wireless network and at the same time may belong to another (neighboring) wireless network as a STA. This may occur in the context of Multi-AP technology which consists in enabling some degree of collaboration among neighboring APs in order to have a more efficient utilization of the limited time, frequency and spatial resources available. With such a technology, two neighboring APs may share resources in terms of frequency or time and, in this way, prevents interferences. APs that collaborate together to share resources are referred to as coordinated APs. Moreover, the data transmission established by coordinated APs is referred as Multi-AP transmission.

While the examples are described in the context of WiFi (RTM) networks, the invention may be used in any type of wireless networks like, for example, mobile phone cellular networks that implement very similar mechanisms.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

An AP manages a set of stations that together organize their accesses to the wireless medium for communication purposes. The stations (including the AP) form a service set, here below referred to as basic service set, BSS (although other terminology can be used). A same physical station acting as an access point may manage two or more BSS (and thus corresponding WLANs): each BSS is thus uniquely identified by a specific basic service set identification, BSSID and managed by a separate virtual AP implemented in the physical AP.

The 802.11 family of standards define various media access control (MAC) mechanisms to drive access to the wireless medium.

The current discussions in the task group 802.11be, as illustrated by draft IEEE P802.11be/D0.4 of March 2021, introduce the Multi-Link Operation (MLO) when it comes to MAC layer operation. The MLO allows multi-link devices to establish or setup multiple links and operate them simultaneously.

A multi-link device (MLD) is a logical entity and has more than one affiliated (AP or non-AP) station (STA) and has a single medium access control (MAC) service access point (SAP) to logical link control (LLC), which includes one MAC data service. Besides, the MLD also comprises a single address associated with the interface, which can be used to communicate on the distribution system medium (DSM).

The stations forming the same MLD may be partly or all collocated within the same device or geographically dispersed.

An access point multi-link device (AP MLD) then corresponds to a MLD where each station (STA) affiliated with the MLD is an AP, referred to as “affiliated AP” hereinafter.

A non-access point multi-link device (non-AP MLD) corresponds to a MLD where each station (STA) affiliated with the MLD is a non-AP station, referred to as “affiliated non-AP station”.

When referring hereinafter to either an MLD AP or a non-MLD AP, the general term “station MLD” may be used.

Depending on the literature, “multilink device”, “ML device” (MLD), “multilink logical entity”, “ML logical entity” (MLE), “multilink set” and “ML set” are synonyms to designate the same type of ML device.

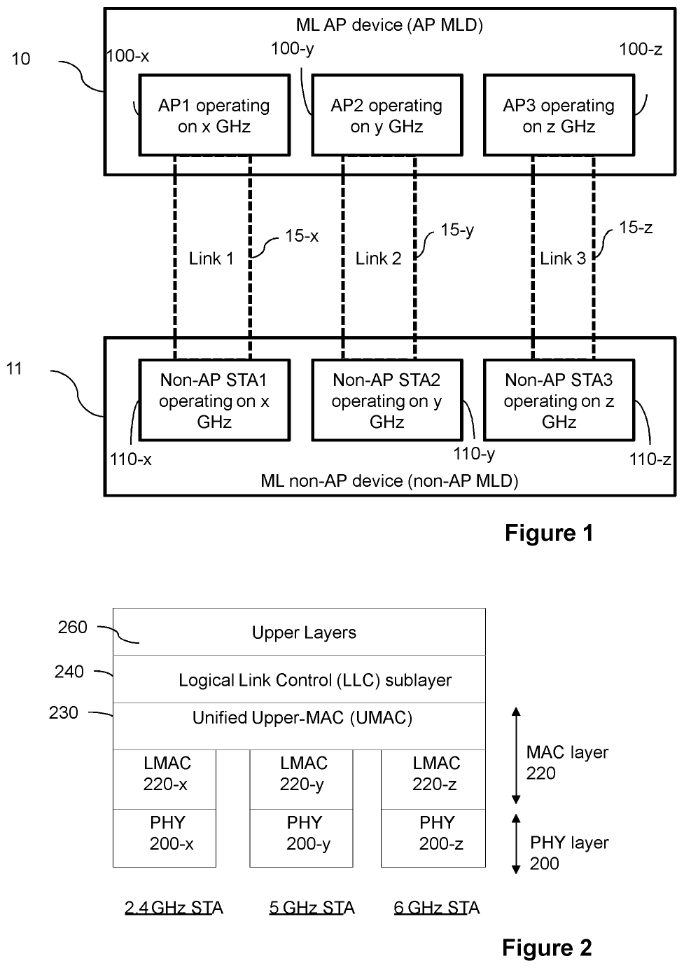

An example of two MLDs, an AP MLD 10 and a non-AP MLD 11 establishing a multilink communication session to exchange data units, in accordance with 802.11be is illustrated in FIG. 1.

As visible, the AP MLD 10 comprises three affiliated APs 100-x, 100-y, and 100-z and the non-AP MLD 11 comprises three affiliated non-AP STAs 110-x, 110-y and 110-z. Although illustrated MLDs are made of three affiliated non-AP stations or APs, MLD with another number of affiliated non-AP stations or APs may be contemplated with the same teachings.

Each station 100-x, 110-x, 100-y, 110-y, 100-z, or 110-z is a logical entity that is a singly addressable instance of a medium access control (MAC) and physical layer (PHY) interface to the wireless medium.

Multiple affiliated non-AP stations of a non-AP MLD may then setup communication links with multiple affiliated APs of an AP MLD, hence forming a multi-link channel.

As visible in FIG. 1, the communication links 15-x, 15-y, 15-z are physical paths usable to transfer MAC service data units (MSDUs) or MAC protocol data units (MPDUs) between an affiliated non-AP station and an affiliated AP. Thus, the communication link 15-x is the communication channel established between the AP 100-x and the non-AP STA 110-x. Similarly, the communication links 15-y and 15-z correspond to the communication channels established between respectively the AP 100-y and the non-AP STA 110-y, and the AP 100-z and the non-AP STA 110-z.

A communication link or “link” thus corresponds to a given channel (e.g., 20 MHZ, 40 MHz, and so on) in a given frequency band (e.g., 2.4 GHZ, 5 GHZ, 6 GHz) between an AP 100-x, 100-y, 100-y affiliated with the AP MLD 10 and a non-AP STA 110-x, 110-y, 110-z affiliated with the non-AP MLD 11.

As visible on FIG. 1, the AP 100-x and the non-AP STA 110-x, the AP 100-y and the non-AP STA 110-y, and the AP 100-z and the non-AP STA 110-z respectively operates at the following frequency bands, x GHz, y GHz and z GHz. These frequency bands may be different one from the other such that the corresponding communication links 15-x, 15-y, 15-z have the respective frequency bands, x GHz, y GHz and z GHz. Alternatively, the links may have the same frequency band, i.e., the STAs may use a same frequency band.

Preferably, the links established for MLDs are considered as fully independent, meaning that the channel access procedure (to the communication medium) and the communication are performed independently on each link. Hence, different links may have different data rates (e.g., due to different bandwidths, number of antennas, etc.) and may be used to communicate different types of information (each over a specific link).

The affiliated APs and non-AP stations may operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can be transmitted across multiple parallel communication links, thereby increasing network capacity and maximizing utilization of available resources.

The terms “traffic” and/or “traffic stream(s)” as used herein, are defined as a data flow and/or stream between wireless devices.

Although FIG. 1 shows a ML AP device and a ML non-AP device establishing a ML communication session, two non-AP MLDs may also establish such a ML communication session.

FIG. 2 illustrates an exemplary 802.11be multi-link reference model for a MLD either AP MLD (e.g., as AP MLD 10 of FIG. 1) or non-AP MLD (e.g., as non-AP MLD 11 of FIG. 1), which may be either originator MLD (i.e., device transmitting data) or a recipient MLD (i.e., device receiving the data from the originator MLD).

The MLD comprises a PHY layer 200, a MAC layer 220, a logical link control (LLC) sublayer 240 and upper layers 260.

Upper layers 260 may include applications which generate traffic data or use received traffic data.

The transmission and the receiving of the traffic data are handled by the MAC 220 and PHY 200 layers. Such transmission and the receiving of the traffic data may be over multiple links, as the one 15-x, 15-y, 15-z introduced with reference to FIG. 1.

The traffic data are provided as a sequence of data frames, known as MAC service data units (MSDUs). Each MSDUs are associated with an access category (AC) as defined in EDCA mechanism.

It is recalled that an 802.11 station (AP and non-AP station) maintains four Access Categories (ACs), and thereby four corresponding emission buffers (or transmission/traffic queues or buffers). Each AC has its own traffic queue/buffer to store corresponding data frames to be transmitted on the network. The four AC are conventionally defined as follows:
AC1 and AC0 are reserved for best effort and background traffic. They have, respectively, the penultimate lowest priority and the lowest priority.
AC3 and AC2 are usually reserved for real-time applications (e.g., voice or video transmission). They have, respectively, the highest priority and the penultimate highest priority.

The data frames, namely the MSDUs, incoming from an upper layer of the protocol stack are mapped onto one of the four AC queues/buffers and thus input in the mapped AC buffer. Therefore, an 802.11 station supports a traffic prioritization similar to DiffServ (Differentiated Services), and the mapping is performed between one of the eight priorities of traffic class of the incoming MSDU onto a corresponding one of the four ACs, according to predefined mapping rules. The traffic class is indicated using a Traffic Identifier (TID) taking values in the range 0 to 7.

Therefore, each MSDU contains an indication relating to the type of data, that is to say, an indication reflecting an access category, in other words, a level of priority.

The 802.11be multi-link reference model reflects the fact that MLDs may transmit using several links, particularly at the level of the MAC layer 220 and the PHY layer.

The MAC layer 220 comprises a Unified Upper-MAC (UMAC) layer 230. The UMAC 230 is responsible for link-agnostic MAC procedures such as sequence number assignments, MPDU encryption/decryption, acknowledgement scoreboarding procedure, etc.

Thus, each data unit, MSDU, arriving at the MAC layer 220 from an upper layer 260 (e.g., Link layer) with a type of traffic (TID) priority is mapped into one of the ACs according to the mapping rule at the UMAC layer 230. Then, still at the UMAC layer 230, the data unit, MSDU, is then stored in a buffer corresponding to the mapped AC.

When an access to the wireless medium is granted, data units are transmitted to the physical (PHY) layer 200 for transmission onto the wireless communication network.

As mentioned before, the transmission may be performed using any of the communication links 15-x, 15-y, or 15-z illustrated on FIG. 1.

Hence, structures of MAC layer and PHY layer are adapted accordingly.

As visible on FIG. 2, the MAC layer 220 of the MLD further comprises multiple blocks, called lower MAC (LMAC) 220-x, 220-y, 220-z for respective multiple links 15-x, 15-y, 15-z.

PHY layer 200 of the MLD comprises multiple PHY blocks 200-x, 200-y, 200-z as well, each being dedicated for respective multiple links 15-x, 15-y, 15-z.

The UMAC layer then further offers a UMAC interface with the link-specific blocks 220-x, 220-y, 220-z (forming lower MAC sublayers, therefore referred to as LMAC) and provides a UMAC Service Access Point (SAP) to the LLC 240 and upper 260 layers.

Of course, the number of blocks depends of the number of links the MLD is able to manage.

In this example, LMAC layer 220-x may be associated with link 15-x via PHY layer 200-x; LMAC layer 220-y may be associated with link 15-y via PHY layer 200-y; and LMAC layer 220-z may be associated with link 15-z via PHY layer 200-z. In other words, each link 15-x, 15-y, 15-z may have an associated LMAC layer 200-x, 200-y, 200-z that performs link-specific features, such as channel, e.g., link, access.

The links 15-x, 15-y, 15-z may be accessed by the respective affiliated stations 110-x, 110-y and 110-z. Further, other stations, for example 802.11 legacy stations, may also operate on these links 15-x, 15-y, 15-z, for communicating with the respective APs 100-x, 100-y and 100-z. Such 802.11 legacy stations are not MLDs, and are capable of operating on any one of the links 15-x, 15-y, 15-z, when exchanging data with a MLD (for example the AP MLD 10). These legacy stations may be non-AP stations or AP stations.

To access the wireless medium, i.e., the links 15-x, 15-y, 15-z, non-AP stations and APs active on a given link may compete using EDCA (Enhanced Distributed Channel Access) contention, in order to be granted a transmission opportunity (TXOP). Then, during the TXOP, the stations may transmit (single-user, SU) data frames.

As an alternative, the affiliated stations and legacy stations may also use a multi-user (MU) scheme to access the wireless medium, i.e., the links 15-x, 15-y, 15-z. In the MU scheme, a single station, usually the AP 100-x, 100-y and 100-z, is allowed to schedule a MU transmission, i.e., multiple simultaneous transmissions to or from other non-AP stations. One implementation of such a MU scheme has been for example adopted in IEEE 802.11 ax amendment standard, as the Multi-User Uplink and Downlink OFDMA (MU UL and DL OFDMA) procedures. Thanks to the MU feature, a non-AP stations has the opportunity to gain access to the wireless medium via two access schemes: the MU scheme and the conventional Enhanced Distributed Channel Access—EDCA scheme, SU scheme.

During a MU DL transmission on the granted communication channel, i.e., the link 15-x, the AP 100-x may perform multiple simultaneous elementary transmissions, over so-called resource units (RUs), to various non-AP stations. As an example, the resource units may split the link 15-x of the wireless network in the frequency domain, based for instance on Orthogonal Frequency Division Multiple Access (OFDMA) technique. The assignment of the RUs to the non-AP stations is signaled at the beginning of the MU Downlink frame, by providing an association identifier (AID) of a non-AP station for each RU defined in the transmission opportunity. AID is individually obtained by each station MLD and each legacy stations during its association procedure with the AP 100-x. AID therefore uniquely identifies the associated legacy station or the associated station MLD (and therefore the affiliated station of the MLD on the current link where the MU frame is emitted), and may be, for example, a 16-bit value.

During a MU UL transmission, various non-AP stations may simultaneously transmit data to the AP 100-x over the resource units forming the link 15-x.

To control the MU UL transmissions of the non-AP, the AP 100-x may previously send a control frame, known as a Trigger Frame (TF). The TF may be used by the AP 100-x to allocate resource units to the non-AP stations of the same BSS, using their AIDs assigned to them during the association procedure to the AP 100-x and/or using reserved AIDs designating a group of non-AP stations. The TF may also define the start of the MU UL transmission by the non-AP stations 110/170-x as well as the length thereof.

When the stations involved in data transmission are affiliated with a MLD, e.g., the affiliated AP 100-x (with MLD 10) and the affiliated non-AP station 110-x (with MLD 11, see FIG. 1), the MLDs, being either originators or recipients, implements a protocol stack, introduced in the 802.11be specifications as described hereinbefore.

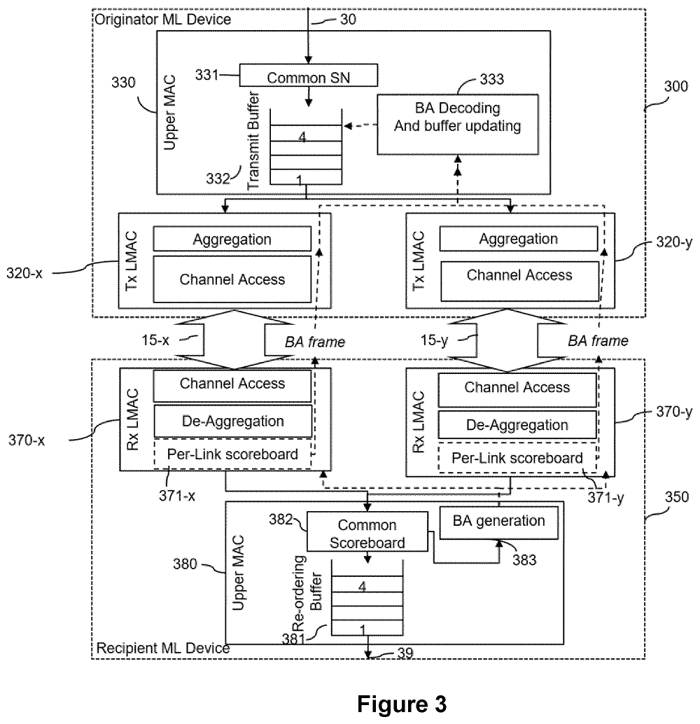

In order to better understand the function of each layer and the blocks of the 802.11be multi-link reference model of FIG. 2, a Multi-Link Operation (MLO), i.e., data transmission at AP or non-AP MLD 300 and data receiving at the AP or non-AP MLD 350, is now described with reference to FIG. 3.

This figure illustrates ML data transmissions between an originator MLD 300 and a recipient MLD 350. For simplicity, the PHY layers are not shown.

The originator and recipient MLD may be both non-AP MLD 11 or AP MLD 10 or one may be an AP MLD 10 and the other may be a non-AP MLD 11.

Any MLD may include the blocks shown at the originator MLD 300 for transmission operations and those at the recipient MLD 350 for reception operations. In the illustrated example, the MLDs 300 and 350 share two links 15-x, 15-y. Of course, depending the number of shared links between the MLDs, the number of blocks LMAC (TxLMAC and RxLMAC), may be adapted accordingly.

To perform multi-link communication, each non-AP MLD establishes a multi-link association with an AP MLD. For the purpose of the association, the association framework allows the non-AP MLD to exchange frames with the AP-MLD.

In practice, one of the links (i.e., one of the affiliated stations of the non-AP MLD) may be used by the non-AP MLD to associate with the AP MLD (through the corresponding affiliated AP station of the AP MLD). This link may be considered as a “primary link” or “anchor link”. Then, discovery procedures may be implemented to discover the other links that can be established between the same non-AP MLD and AP MLD.

Exchanged information during the association procedure may include BSS configuration, AP information on each link, i.e., information relating to the affiliated station of the non-AP MLD associated with each link, non-AP STA information on each link, i.e., information relating to the affiliated AP stations of the AP MLD associated with each link, capability of each link, Tx/Rx constraints of the multiple links.

Each time a MLD needs to exchange data with another associated MLD, it establishes a multilink communication session.

The multilink communication session first comprises a setup phase. During the setup phase, the originator MLD may exchange information and negotiate policies for the multiple links of the ML communication session. Also, one or more links may be established at a specific time: establishing a link means that each MLD has all the information to enable data operation (transmission or receiving) with the other MLD sharing that link.

The negotiated policies may include an acknowledgment (ack) scheme, in particular an agreement regarding the terms and capabilities for Block Acknowledgement (BA) procedure.

BA procedure proposes during a BA session to confirm the receiving of data transmitted using a link 15-x or 15-y, e.g., with the help of an add BA (ADDBA) request and response procedure, for each link.

When negotiating regarding BA procedure, the negotiating MLD may exchange capability information such as BA size (size of scoreboard bitmaps), buffer size, window size (e.g., a sliding window), the sequence number space to be used, and/or policy, and then agree on the common parameters to use. The obtained BA agreement may be later cancelled (e.g., using a delete BA (DELBA) request).

The BA agreement is negotiated at the UMAC level 330, 380 for a given traffic, for example for a given value of TID, and this regardless of the one or more links to be used for the transmission of this traffic. Indeed, thanks to the multilink scheme, the data units belonging to the same TID can be simultaneously transmitted over multiple links.

For each BA agreement (i.e., in case several TIDs are transmitted in parallel), there is an associated reordering buffer at recipient MLD.

The BA procedure will be better understood with the illustrated transmission from the originator MLD 300 to the recipient MLD 350.

The UMAC 330 of the originator MLD 300 receives application data 30 as an input to be transmitted to the recipient MLD 350. Application data may be in the form of several MSDUs. Based on the received MSDUs, the UMAC may form individual MPDUs associated to the received MSDUs or an A-MSDU according to an A-MSDU aggregation.

Then, data units are stored in the transmit queue or buffer 332, and are associated with sequence numbers to keep information regarding their order.

For example, the UMAC 330 attaches a sequence number (SN) to the MPDUs at block 331 and allocates these MPDUs to a common transmit queue 332. The sequence numbering is determined using a starting sequence number and the sequence number space which is the difference between two consecutive sequence numbers. Information relating to sequence numbering are shared between the originator MLD 300 and the recipient MLD 350.

Alternatively, the common transmit queue 332 may store directly MSDUs (and not MPDUs), each being associated to a SN by the UMAC. In this case, the sequence numbering is chosen in order to ensure that the SN of MSDU frame(s) corresponds to a given MPDU encapsulation.

The common transmit queue 332 is a single transmit queue used for all four ACs, i.e., all traffics. According to some embodiments, multiple transmit queues may be used, each of which being associated with a respective AC.

The stored data units may then be routed from the transmit queue 332 to one of Tx LMAC 320-x or Tx LMAC 320-y layers (i.e., to one of its affiliated stations), usually depending on the allocation of data units (MPDUs) to the multiple links 15-x, 15-y which is performed by the UMAC 330. For example, if link 15-x provides communication resources for the MLD originator 300, then the data units are routed to the Tx LMAC 320-x layer.

The data units may then be transmitted over the multiple links, for instance using MPDU aggregation and channel access.

MU schemes and SU schemes may be used for the data transmission over a given link independently of the multiple links. In particular, one of MU schemes that has been adopted by the IEEE in the 802.11ax-2021 standard, could be implemented independently on each link.

The transmitted data units are then received by the recipient MLD 350 through its multiple affiliated stations, i.e., through its multiple Rx LMAC 370-x, 370-y layers according to the link 15-x, 15-y on which the originator has transmitted the data units.

At the recipient MLD 350, a block acknowledgment (BA) may be independently performed per link.

To do that, a scoreboard, blocks 371-x and 371-y, may be built, listing the received data units. Next, the scoreboard may be sent to the originator MLD as a BA frame, upon receiving a request from the MLD originator, i.e., BA Request, or upon receiving a number of data units, over the corresponding link.

For example, during a TXOP session on one of the links 15-x or 15-y, the BA frame is sent by the recipient MLD 350 in order to close de communication according to the “Immediate Block Ack” policy which specifies that the BA frame should be received during the TXOP session.

The per-link scoreboard 370-x, 370-y may be a BA bitmap comprising bits associated with respective sequence number (from an agreed starting sequence number, SSN). The bits may respectively take the 0-value if the data unit with the corresponding sequence number has not been correctly received over the associated link at the time of building the bitmap or the 1-value if the data unit has been correctly received. The BA bitmap may be generated for a particular traffic, e.g., based on a TID value.

According to some embodiments, per-link scoreboards 370-x, 370-y may be implemented as partial-state of reception.

The BA mechanism aggregates several acknowledgements into one frame which improves channel efficiency.

The received and decoded data units are forwarded by each Rx LMAC 370 layer to UMAC 380 layer for storage in a common re-ordering buffer 381 (i.e., a common receive queue). In that way, the UMAC layer 380 may consolidate the data units arriving over the multiple links, perform BA scoreboarding, MPDUs reordering, etc. Again, a shared common re-ordering buffer 381 may be used for the four EDCA ACs, or multiple re-ordering buffers may be used.

As illustrated, the recipient MLD 350 may also maintain a common scoreboard 382 to keep a longer-term record of the received data units for multilink data transmissions for a given TID, not limited by TXOPs.

The common scoreboard 382 may be implemented as full-state. The common scoreboard 382 may be updated regularly with the content of the per-link scoreboards 370-x, 370-y. For example, the common scoreboard is updated every time a per-link scoreboard is updated, or at least at the end of TXOPs of each link. The common scoreboard has thus a bigger size than the per-link scoreboards 370-x, 370-y. Still, the common score board is generated for a given TID. The common scoreboard 382 is used by the BA generation block 383 to generate a BA frame.

The BA frame is transmitted to the originator MLD 300 using one or more of the multiple links 15-x, 15-y. A single BA may be sent back for the multiple links 15, preferably upon receiving a BA Request from the originator MLD 300.

Typically, the recipient MLD 350 may transmit the bitmap of several BA sessions, long after the end of the related TXOP sessions. Such implementation thus allows “Delayed Block Ack”, and also supports an “Immediate Block Ack” policy if the MLD 350 is responsive enough.

The received BA frame and/or the per-link scoreboard 370-x, 370-y (also BA frames) are used by the originator MLD 300 to manage transmit buffer 332, in particular to remove acknowledged data units (MPDUs and so the corresponding encapsulated MSDUS) therefrom based on their acknowledgment by the recipient.

At the recipient side, the received data units are reordered upon arrival at the UMAC layer 380 and then stored in the re-ordering buffer 381 in the original order. The receive reordering buffer operation is based on the Sequence Number space that is shared between the two MLD 300, 350.

Next, data units are successively provided (arrow 39) to the upper layers 260 (FIG. 2) following the original order, meaning that the preceding data unit (according to the sequence numbering) have to be yet delivered before the next correctly received data unit is delivered to the upper layers.

Therefore, through multi-link aggregation, MPDUs that belong to the same TID can be transmitted on multiple links. Even if BA agreement is established per TID, meaning that all links for a given TID have the same ACK policy, the transmission is generally independent, in terms of timing and resource allocation, from the other link to another(s). By default, all TIDs are mapped to all setup links for both UL and DL directions, a non-AP MLD can use any link within this set of enabled links to transmit frames carrying MSDUs or A-MSDUs with that TID.

As mentioned before, the transmission on each link 15-x, 15-y may be performed according SU or MU schemes. MU schemes being more efficient, the use of MLO together with MU scheme enables to increase the peak/average throughput of the MLDs.

As defined in 802.11 network protocol, data transmissions based on MU scheme are scheduled transmissions based on the transmission needs declared by the non-AP stations to the AP. For example, the non-AP stations may use a Buffer Status Report (BSR) for declaring their transmission need. Hence, “transmission needs”, “amount of data to be transmission”, “amount of buffered data”, “resource allocation needs” are considered synonymous in the present document.

With the BSR mechanism, the non-AP stations report to the AP the amount of data held in an emission buffer ready to be transmitted to the AP, i.e., the amount of buffered uplink (UL) traffic. The BSR mechanism is consequently adapted to report the amount of data held in the emission buffers corresponding to a given TID.

The information contained in the received BSRs makes it possible for the AP to schedule a MU UL transmission. This scheduling comprises selecting the non-AP stations to which MU UL transmissions are offered and to determine UL resource units to be allocated to each of the selected non-AP stations in terms of bandwidth and duration. Accordingly, each non-AP station having data to be transmitted is provided with the radio resources adapted for the transmission.

This mechanism is able to guarantee that a non-AP station, having data to transmit, gets an opportunity to proceed to the transmission of these data. Based on the knowledge of the amount of data awaiting to be transmitted at each non-AP station, the AP manages the scheduling for an efficient use of the available radio resource.

In the multi-link device context, the scheduling is made by one affiliated AP stations of the AP MLD. The affiliated AP of an AP MLD performs a scheduling per link based on BSR reports containing information related to the common transmit buffer 332 common to all setup links, and common to all the types of traffics.

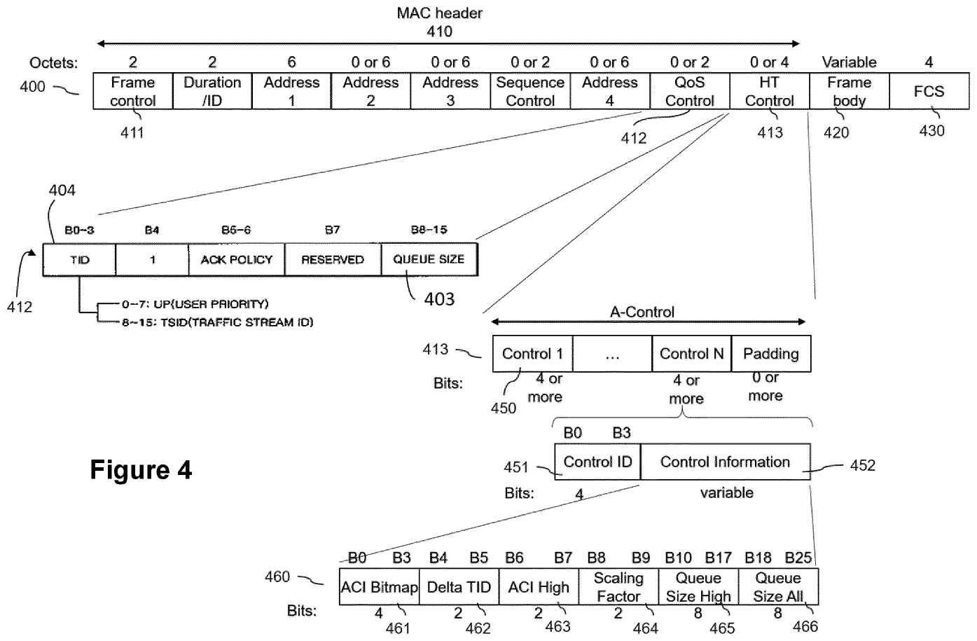

FIG. 4 illustrates an example of BSR included in a BSR control field provided in MAC data frames.

The illustrated MAC data frame 400 comprises a MAC header 410, a frame body 420 and an FCS field 430. The MAC header 410 includes, amongst other fields, a Frame Control header 411, a QoS control field 412 and a HT control field 413. The QoS control field 412 is the original 802.11e format that may be used by a non-AP station of any 802.11 technology to report a buffer status.

Alternatively, or possibly additionally, a non-AP station starting from 802.11ax version (including further releases such as 802.11 be/EHT) may use the HT control field 413 to do so.

Thus, the field 413 may be indifferently referred to as HT or HE or EHT Control field according to the 802.11 generation considered (respectively 802.11ac, 802.11ax or 802.11be) when provided inside the 802.11 MAC Data Frame 400.

### 802.11 Legacy BSR Format

As illustrated, the QoS control field 412 is made of two bytes, including the following information items:
Bits B0 to B3 are used to store a traffic identifier (TID) 404 which identifies a traffic stream. The traffic identifier takes the value of the transmission priority value (User Priority UP, value between 0 and 7) corresponding to the data conveyed by the data frame or takes the value of a traffic stream identifier, TSID, value between 8 and 15, for other data streams;
Bit B4 is used by a non-AP station to differentiate the meaning of bits B8-B15 and is detailed here below;
Bits B5 and B6 define the ACK policy subfield which specifies the acknowledgment policy associated with the data frame. This subfield is used to determine how the data frame has to be acknowledged by the receiving station; normal ACK, no ACK or Block ACK.
Bit B7 is reserved, meaning not used by the current 802.11 standards; and
If bit B4 is set to 1, bits B8-B15 represent the “queue size” subfield 403, to indicate the amount of buffered traffic for the TID 404 specified in bits B0-B3 at the non-AP station sending this frame. The queue size value is the total size, rounded up to the nearest multiple of 256 octets and expressed in units of 256 octets, of all packets buffered for the specified TID. The access point may use this information to determine the next TXOP duration it will grant to the station. A queue size of 0 indicates the absence of any buffered traffic for that TID. A queue size of 255 indicates an unspecified or unknown size for that TID 404.
Alternatively to the “queue size” usage, if bit B4 is set to 0, bits B8-B15 represent the “TXOP Duration Requested” subfield. It indicates the duration, in units of 32 us that the sending station determines it needs for its next TXOP for the specified TID. Of course, the “TXOP Duration Requested” provides an equivalent request as the “queue size”, as they both consider all packets buffered for the specified TID.

The following description will be done with “queue size” format for the buffer status reports, as it is the largest usage (the “TXOP Duration Requested” format is deprecated for MU usage). The 802.11e MAC frame format, and more particularly the QoS Control field 412, have been kept for the up and corner standard versions as now described.

The legacy BSR according to 802.11e can handle one TID report per MSDU frame, this is one reason why enhancements were later provided by 802.11ax version.

### 802.11ax BSR Format

The HT-Control field 413 may aggregate multiple (N in the figure) control fields, resulting in a sequence of one or more Control subfields 450. The length of the aggregated control field (A-Control field) 413 is equal to 30 bits.

Each Control subfield 450 includes a Control ID 451 subfield indicating the type of information carried in the Control Information subfield 452 that follows. Padding bits are added if necessary to reach the 30 bits of the A-Control field.

Various type of information may thus be provided through the A-Control field 413 depending on the Control ID 451. For instance, operating modes may be indicated in Control Information subfield 452 when Control ID 451 is 1. Also, power data may be indicated in Control Information subfield 452 when Control ID 451 is 4.

If Control ID subfield 451 is 3, Control Information subfield 452 of the Control subfield 450 contains buffer status information in the format of a BSR control field shown in the figure under reference 460.

A non-AP station may report the buffer status for a preferred AC or for all AC queues.

The Buffer Status Information 460 is made up of six subfields: ACI Bitmap 461, Delta TID 462, ACI High 463, Scaling Factor 464, Queue Size High 465 and Queue Size All 466.

A number NTID of traffic identifiers for which there is buffered uplink, UL, traffic, is signaled using the first two subfields in the BSR control field 460, namely ACI Bitmap 461 and Delta TID 462.

ACI Bitmap subfield 461 has four bits and indicates the access categories for which the buffer status is reported. Each bit of the ACI Bitmap subfield 461 is associated with one of the four ACs and is set to 1 to indicate that the buffer status of the corresponding AC is included in the Queue Size All subfield 466, otherwise it is set to 0.

Exception is made for the particular case where the buffer statuses for all eight TIDs are included in the Queue Size All subfield 466. In that case ACI Bitmap subfield=0 is combined with Delta TID subfield 462 set to 3.

Delta TID subfield 462 together with the values of the ACI Bitmap subfield, indicate the number of TIDs for which the non-AP station is reporting the buffer status. The table below gives the relationships between these two subfields and the number of TIDs. The table comes from table 9-24e of document 802.11ax, version 8.0.

| Number N_{bit} of bits | Mapping of Delta TID |
|---|---|
| in ACI Bitmap subfield 461 | subfield value and number |
| that are set to 1 | of TIDs, N_{TID} |
| 0 | Values 0 to 2 are not applicable; |
| | Value 3 indicates 8 TIDs |
| | (i.e., all ACs have traffic) |
| 1 | Value 0 indicates 1 TID; |
| | Value 1 indicates 2 TIDs; |
| | Values 2 to 3 are not applicable; |
| 2 | Value 0 indicates 2 TIDs; |
| | Value 1 indicates 3 TIDs; |
| | Value 2 indicates 4 TIDs; |
| | Value 3 is not applicable; |
| 3 | Value 0 indicates 3 TIDs; |
| | Value 1 indicates 4 TIDs; |
| | Value 2 indicates 5 TIDs; |
| | Value 3 indicates 6 TIDs; |
| 4 | Value 0 indicates 4 TIDs; |
| | Value 1 indicates 5 TIDs; |
| | Value 2 indicates 6 TIDs; |
| | Value 3 indicates 7 TIDs; |

ACI High subfield 463 is used to indicate the ACI (Access Control Identifier) of a preferred AC for which the amount of buffered traffic is specified in Queue Size High subfield 465.

Scaling Factor subfield 464 indicates the unit SF, in octets, of Queue Size High and Queue Size All subfields 465, 466.

Queue Size High subfield 465 indicates the amount of buffered traffic, in units of SF octets, for the AC identified by ACI High subfield 463 that is intended for the station (usually the AP) identified by the receiver address of the MAC frame 400.

Queue Size All subfield 466 indicates the amount of buffered traffic, in units of SF octets, for all the ACs identified by ACI Bitmap subfield 461 that is intended for the station (usually the AP) identified by the receiver address of the MAC frame 400.

The queue size values set in Queue Size High and Queue Size All subfields 465, 466 are the total sizes, rounded up to the nearest multiple of SF octets, of all MSDUs and A-MSDUs buffered at the non-AP station reporting its buffer statuses.

The standardized 802.11ax BSR remains dedicated to the reporting of buffer statuses from one (or several) of the 4 queues. This format is no longer compliant with TID values greater than 7, whereas the legacy format is still. For instance, upper layers may provide data frame, MSDU, with 802.1D User Priority (UP) values taken in the reserved 8-15 values (known as TSID) for low latency delivery services.

Historically, the IEEE 802.11e introduced the usage of TSID along with the traffic specification (TSPEC) for a contention-free mechanism called HCCA (standing for HCF Controlled Channel Access), which has become deprecated with 802.11ax. The 802.11ax provided a centralized polling scheme by the AP for MU communications, but remains deficient in handling a real QoS as required for low latency services.

As 802.11be aims to assess its ability to handle Real-Time (RT) traffic, using TSID is an easy traffic indication means for selecting the appropriate transmission mode of operation. A possibility is to refine TSPEC (Traffic SPECification), as a set of QoS parameters that are used to describe a TS (Traffic Stream) seen as a specific data flow between two stations.

The station may include the TSPEC in some action frames, like the Add Traffic Stream (ADDTS), to perform an admission request or closure of the characterized traffic.

Once the access point has obtained traffic specifications and/or buffer reports for a set of stations of its BSS, it can specifically poll them through scheduled resource unit allocation. This allocation is transmitted using a trigger frame for data transmission. Then, the stations with allocated resource units emit their buffered data inside their allocated resource unit or units. As the MU UL/DL OFDMA transmissions on all the resource units of the composite channel should be aligned in time, the station may provide padding payload in case of no more data can be sent inside the assigned resource unit. This may happen, for example, if no more data is buffered for transmission, or if the emitting station doesn't want to fragment any remaining data frame.

Current BSR procedure provides a protocol for AP to acquire buffer status of each AC, i.e., each traffic, on the non-AP side, so that AP can send trigger frames to trigger UL traffic. Therefore, current BSR approach enables a non-AP MLD to provide the AP MLD with its transmission needs globally, without considering that the AP MLD is able to schedule data transmission on link basis.

However, when scheduling over links, the AP MLD does not have precise information relating to the links, and for example the AP MLD may not be aware of disturbances on some links. Indeed, when choosing a link, the AP MLD does not offer any guarantee regarding the latency, reliability or jitter of the transmission, which mainly depends on radio reception at the non-AP MLD side.

Indeed, the non-AP MLD is well aware of its radio environment such that, knowing that some radio links are experiencing disturbances, the non-AP MLD is in a better position to determine the optimal link for data transmission at a given time.

Thus, the AP MLD, which only considers the competition between the stations, may sometimes give an uplink transmission opportunity to the station on an unsuitable link.

Therefore, there exists a need to improve the MU UL transmissions in the MLD context, particularly in order to improve transmission reliability while ensuring low latency.

The present invention seeks to improve the scheduling of the wireless resources for multi-user transmission in the context of MLOs that is emerging for 802.11be standard.

The invention also applies to SU UL transmissions, as described hereinbefore.

According to a first aspect, the invention proposes to use a specific buffer status report adapted to multi-link devices, a multi-link buffer status report (ML-BSR), enabling each non-AP MLD to report for all traffics or for given traffic(s), the buffered amount of data awaiting to be transmitted together with a link, identified by the non-AP MLD, on which the non-AP MLD expects to be scheduled for transmitting the reported amount of data.

Receiving such ML-BSR, the AP MLD is then in possession of an additional information, regarding the link considered by the non-AP, as being the more adapted for a subsequent scheduling for an UL transmission, either in SU or MU mode.

Therefore, the AP MLD transmits to the non-AP MLD scheduling information regarding the transmission of the reported data in the ML-BSR. Scheduling information may take or not into consideration the indication of the ML-BSR regarding to the link on which the non-AP MLD expects to be scheduled.

Indeed, the AP MLD schedules the non-AP MLD taking into consideration both the competition between the station but also the link chosen by the non-AP MLD according to their radio environment. According to the constraints, the AP may or not schedule an UL transmission using the indicated link (in SU mode) or a resource unit on the indicated link (in MU mode).

Therefore, the core of the invention aims at enabling the non-AP MLD to provide along with an amount of data reported by station in a BSR, an associated indication about a link over which the station expects to be scheduled by the AP.

Embodiments of the invention may apply to any MLD, non-AP or AP, for which resources are to be scheduled by an AP MLD. The MLD (which may also be referred to as a scheduled MLD) may then provide information about its traffic needs and link constraints to the scheduling station according to embodiments of the invention.

For example, in the case of P2P links established between MLDs of a P2P group of stations, a coordinator station (e.g., Group Owner, or a device acting as software AP according to Wi-Fi Direct protocol), acting as a scheduling station for the P2P group, has to know the real-time information of other stations of the group.

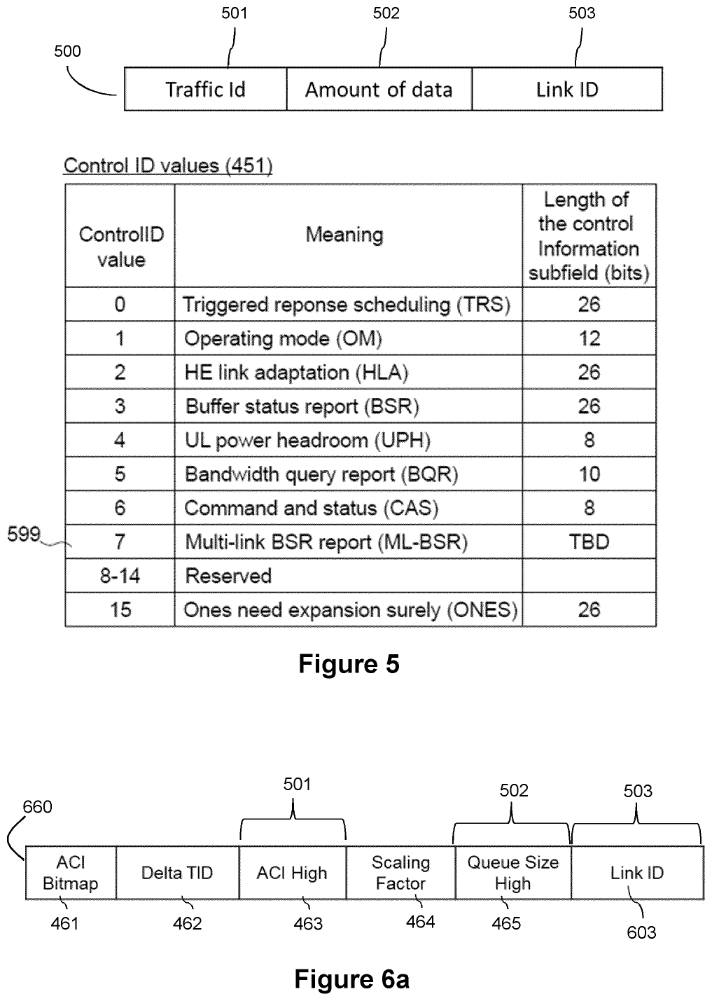

Embodiments of the present invention are now illustrated through a new format of report for low-latency traffics as illustrated in FIG. 5.

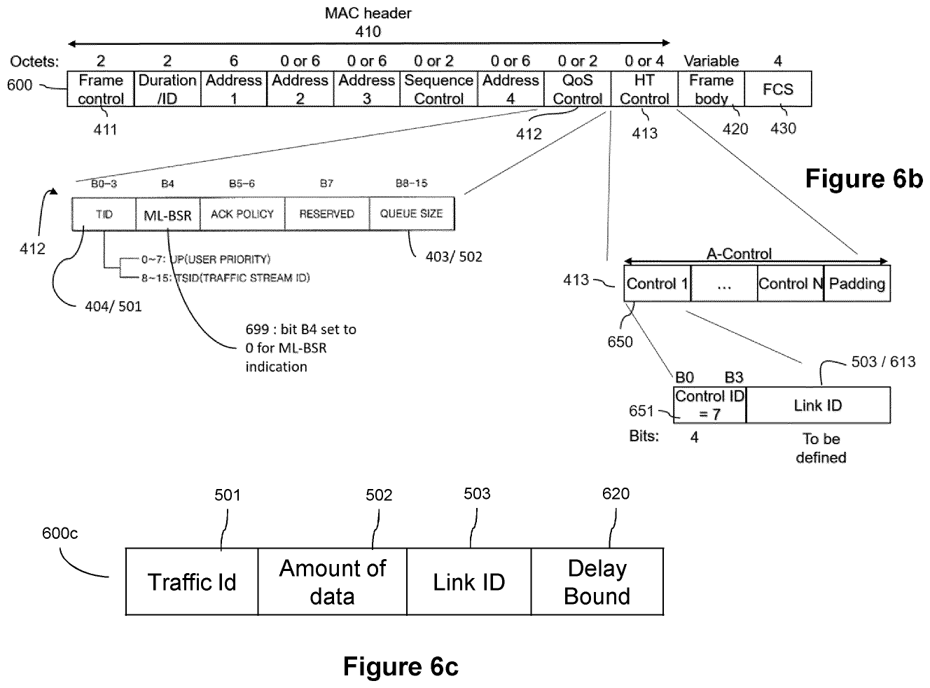

The proposed format 500 aims at being generic, in the sense it could be declined in a new independent format, as illustrated by FIG. 5, or part of the format may be added to various existing types of reports, for example, in the legacy buffer status as illustrated in FIG. 6a, or the 802.11 ax buffer status as illustrated in FIG. 6b, or any combination of those.

In some embodiments, at least a part of the report 500 is to be conveyed through the A-Control subfield 413 of the MAC header 410, as illustrated in FIG. 4. For instance, it may be indicated in Control Information subfield 452 when Control ID subfield 451 takes the value 7, values 8 up to 15 remaining reserved (see FIG. 5).

The report 500 is referred hereinafter as Multi-Link Buffer Status report (ML-BSR). According to some embodiments, the usage of the ML-BSR is indicated through new entry 599 (e.g., Control ID having one value in between 7 to 14) in the Control ID table for A-Control fields.

As visible in FIG. 5, the ML-BSR includes an indication relating to amount of data awaiting to be transmitted, associated with a link indication, on which the non-AP ML expects to receives the data to be transmitted.

Thus, the ML-BSR 500 is composed of a Traffic Id subfield 501, an amount of data subfield 502, and a Link ID 503.

The first field 501 comprises an indication relating to the type of data for which the ML-BSR applies.

The type of data may be for example the traffic for which the ML-BSR is issued. Depending on the delivery service negotiated between the ML AP and the non-AP ML station generating the report, it may appear that the traffic indication may be of two forms: per-class report and per-flow report.

The traffic flows, having the same class, also share the same traffic queue. Thus, with per-class report, said traffic queue is considered in the report: the indication is then either an AC value indicative of an Access Category or a TID indicative of a Type of Traffic (i.e., User priority).

In a ML-BSR per-flow report, only a specific high layer traffic is considered by the report. Thus, the resource reservation by the AP is only contemplated for the specific high layer traffic. To do that, the station uses an identifier of the specific traffic flow. Such identifiers enable the station to create, modify or delete several types of traffics. For example, the identifier may be either a TSID indicative of a parameterized traffic or a Stream Classification Service identification, SCSID, according to Stream Classification Service (SCS) of 802.11aa.

According to some embodiments, the identifier may be TWT Flow Identifier of a Target Wake Time (TWT) service period. TWT protocol allows an AP to manage activity in the network, in order to minimize medium contention between Stations (STAs), and to reduce the required amount of time that a STA in the power-save mode needs to be awake.

According to some embodiments, the ID subfield 501 this subfield may be 8-bit long: values 0-7 are set for identifying a User Priority for either a Traffic Category (TC) or Traffic Stream (TS).

Values 8-15 are set for identifying a TSID.

Values 16-31 are set for identifying a SCSID (wherein the Stream Classification Service IDentifier, SCSID, value is determined by bit-masking with 0xF).

Values 32-47 are set for identifying TWT Flow Identifier in the case that the low-latency traffic flow follows a TWT service period (wherein the TWT Flow ID value is determined by bit-masking with 0xF).

According to some embodiments, the ML-BSR may be a report for a P2P traffic. In this case, the traffic identification 501 may be the AID of the receiving peer station.

Alternatively, a session identifier corresponding to the direct link session (e.g., identifier of the established direct link) may be used as a traffic identification 501. Such traffic identification 501 may be adapted when the AP has allowed the P2P session (for example, for DLS protocol) and has granted an identifier for this session. According to some embodiments, the session identifier in an AID format of 12 bits, but takes different values of the one used for AID of the stations. It is up to the AP to allocate distinct values compared to AID of stations.

Besides, the format 500 comprises an indication relative to the amount of data awaiting to be transmitted by the non-AP MLD. The amount of data 502 corresponds to the count of buffered data units that are relevant for the present buffer reporting, i.e., data units relating to the considered traffic in the ML-BSR.

Additionally, the format 500 comprises an indication relating to the link on which the station expects to be scheduled by the AP MLD. The non-AP MLD, i.e., the affiliated stations, being aware of the disturbances occurring on the links, provides within the ML-BSR the indication of at least one link which is best adapted for the transmission of the amount of data awaiting to be transmitted. Further, when selecting the link, the non-AP MLD may further take into consideration the reported amount of data.

In the FIG. 5, the Link ID subfield 503 indicates the link identifier of the reporting MLD to which the reported amount of data is related to. The Link ID subfield is set to 15 if the reported amount of data is global and no part has to be transmitted on a given Link, or if the reporting device does not have that information.

The Link ID is a current information for the AP, which helps simplicity and efficiency for scheduling next communication slots for the indicated Link. It shall be noted that the term “AP ID” could be used in place of “Link ID”.

Indeed, the term “link” is often used for designating an entity that connect two endpoints, an affiliated station of the non-AP MLD and an affiliated AP of the MLD. From that perspective, in some embodiments, an affiliated AP can terminate several links, such that the AP ID is more appropriate as the Link ID. Following embodiments are described hereinafter with reference to the Link ID.

Such a ML-BSR is therefore a mean for an originator non-AP MLD to help the scheduling AP MLD for ensuring that all awaiting data are delivered on time on the intended link.

The ML-BSR is a “live” information, or temporary information for subsequent scheduling. One shall note the difference with the TID-to-link mapping mechanism, which is more static configuration mechanism allowing an AP MLD and a non-AP MLD that performed multi-link setup to determine how TIDs are mapped to the setup links in DL and in UL. The benefit of the ML-BSR is to propose to adapt the operating over the opened links (those that were setup by the TID-to-link mapping mechanism) in view of a current situation of the amount of data awaiting to be sent.

The ML-BSR is sent by the non-AP MLD using any of the opened links between the non-AP MLD and the AP MLD, indifferently of the Link ID indicated in the report.

While the ML-BSR is described with regards to a traffic flow, it is not limited to application to one single traffic. As a station may embed several multimedia traffics, each having widely varying characteristics, then the station may designate, over time, different links on which the station is expecting to be scheduled, for different traffics.

Receiving such a ML-BSR at the AP helps the AP MLD to manage traffics. Indeed, the ML-BSR is used by the non-AP MLD to inform the AP MLD of an instantaneous global transmission need over a given link for a given traffic, in the case of the use of per-class report format considering several flows.

Another benefit of ML-BSR, when used in the context of TWT protocol, is that such ML-BSR report may also simplify the TWT SPs negotiation by not requiring a detailed traffic specification: indeed, the scheduled station may regularly inform using a ML-BSR its needs among the set of links with regards to next Service Period(s) (SP) boundaries.

One may note that the usage of ML-BSR format can be broaden to numerous implementation specific algorithms for network resource allocation over multiple links.

Now, several example of ML-BSR are described in relation to FIGS. 6a, 6b and 6c. Indeed, still according to the first aspect of the invention, a frame comprising a ML-BSR format as described hereinbefore is provided.

According to some embodiments, a non-AP MLD, scheduled station, delivers buffer status reports (BSRs) to assist the AP MLD, scheduling station, in allocating UL MU resources or in allocating a link for the UL transmission.

The non-AP MLD can either implicitly deliver ML-BSRs in the couple QoS Control field 412/BSR Control subfield 650, or in the BSR Control subfield 660 of any frame transmitted to the AP, unsolicited ML-BSR, or explicitly deliver BSRs in any frame sent to the AP in response to a ML-BSRP Trigger frame, solicited ML-BSR.

According to some embodiments, an 802.11be/EHT station (AP and non-AP) according to embodiments of the invention may set a ML-BSR Support subfield in the EHT Capabilities element it transmits to 1; otherwise, the station may set the ML-BSR Support subfield to 0. Thus, the ML-BSR Support subfield is therefore used by the non-AP MLD in order to indicate to the AP MLD, during the association procedure, whether the non-AP MLD supports ML-BSR.

FIG. 6a illustrates, according to some embodiments, a ML-BSR 660 which is based on BSR Control field 460 of FIG. 4 according to 802.11 ax.

According to the invention, the ML-BSR 660 comprises the fields described in relation to the BSR in the 802.11ax format: the ACI Bitmap field 461, the Delta TID field 462, the ACI High field 463, the Scaling Factor 464, the Queue size high 465.

Further to these known subfields, the invention proposes to add a Link ID field 603.

The ML-BSR report format according to the invention, respectively corresponds to the following fields: ACI High field 463, the Scaling Factor 464, the Queue size high 465 and the Link ID field 603.

The ACI High subfield indicates the ACI of the AC for which the ML-BSR is indicated in the Queue Size High subfield.

In other words, the ACI High subfield 463 indicates the ACI of the AC for which the ML-BSR is established. Thus, the ACI High indicates the AC for which the buffer status is reported in the Queue Size High 465, i.e., the amount of data awaiting to be sent for the indicated AC, corresponding to the field 502 of FIG. 5.

Still, the Scaling Factor subfield indicates the unit SF, in octets, of the Queue Size High subfield.

The unit used for the reported amount of data is specified in the Scaling Factor subfield 464.

The Queue Size High subfield indicates the amount of buffered traffic, in units of SF octets, for the AC identified by the ACI High subfield that is intended for the STA identified by the receiver address of the frame containing the ML-BSR Control subfield, and that is intended to be delivered via the link specified by the Link ID subfield.

Therefore, the Queue Size High 465 subfield corresponds to the field 502 of FIG. 5.

The ML-BSR further comprises an indication relating the link on which the station expects to be scheduled for transmitting the buffered data specified in the Queue Size High 465. This indication is comprised in the Link ID field 603, indicating that the buffered data of the Queue Size High 465 is intended to be delivered via the link specified by the Link ID subfield.

The ‘Link ID’ subfield 603 is 4-bits in length and indicates the link identifier that the reporting STA aims to transmit the specified amount of data traffic. The STA identified by the receiver address of the frame containing the ML-BSR Control subfield (e.g., ML AP) is expected to schedule frames buffered at station emitting the ML-BSR for delivery on the link specified by this Link ID subfield 603.

The other subfields are not used for the ML-BSR report.

According to 802.11ax standard, the ACI Bitmap subfield 461 indicates the access categories for which the buffer status is reported, namely the Queue Size All 466.

According to some embodiments, the Queue Size All 466 may no longer be reported. Thus, the location of the Queue Size All subfield may be used for a Link ID subfield 603. A specific number of bits in the ACI Bitmap subfield 461 set to 0 may indicate that the report is a ML-BSR, such that the change of location is correctly interpreted.

As a result, receiving station will consider the buffer status 660 as a ML-BSR in the case where the ACI Bitmap subfield is 0 and the Delta TID subfield is different from 3 (because this value is already used in 802.11ax in this context of ACI Bitmap set to 0).

According to some embodiments, the Delta TID subfield is set to 0 as this value is not applicable for 802.11ax.

According to some embodiments, the ML-BSR may be based on the QoS Control field 412 of FIG. 4 as illustrated in FIG. 6b.

In this example, the buffer status reported in the QoS Control field 412 consists of a queue size value, i.e., the size of the amount of data awaiting to be sent by the station, for the TID 404 indicated in B0-B3.

According to some embodiments, a reporting station (in order to be further scheduled) may report the queue size for a given TID using the Queue Size subfield 403/502 of the QoS Control field in either QoS Data frame or QoS Null frame.

According to some embodiments, the station may use the B4 to indicates whether the BSR is a ML-BSR. For example, the bit B4, ML-BSR indication bit 699, is set to 0 to indicate that the BSR is an ML-BSR.

The indication relating to the link on which the non-AP MLD expects to be scheduled to transmit the data indicated in the Queue Size 403/502, i.e., Link ID information, is present in a Link ID subfield 503/613 of a ML-BSR Control subfield 650. The size in bits of the Link ID subfield 613 may be chosen in an appropriate manner.

For a reported BSR having a B4 set to 0, there shall have at most one ML-BSR present, i.e., the associated subfields forming the ML-BSR.

Several ML-BSR may be reported in an A-MPDU, in which multiple 802.11 QoS frames (more specifically QoS Data frames and QoS Null frames) are aggregated.

According to some embodiments, the ML-BSR may report the queue size and a delay bound for a given TID.

In the illustrated example, the legacy QoS Control 412 and the Control subfield 650 comprising an indication representative of the Link ID 613 form together a ML-BSR.

Of course, this example is non-limitative.

For example, the same principle may be applied for 802.11ax BSR formats.

According to some embodiments, a QoS frame comprising a Control subfield 650 representative of BSR control field 460 may be followed by a subsequent QoS frame embedding a Control subfield 650 representative of a Link ID 613, which together form a ML-BSR according to a variant.

Advantage of embodiments described with reference to FIGS. 6a and 6b, is to reuse existing BSR formats and/or codes, and to ensure backward compatibility.

Indeed, as the BSR information is located in MAC header, so both HE/EHT formats are supported: the EHT stations can use it in legacy HE format or EHT format according to the invention (in case of presence of ML-BSR Control subfield 651). For the legacy HE stations, the presence of ML-BSR Control subfield 651 is ignored by HE recipient. HE recipient stations are by essence single-link operating such that a reported BSR reflects the buffer requirement for said single link.

FIG. 6c presents an alternative embodiment, in which the ML-BSR further comprises an indication relating to a time limit for transmitting the amount of data contained in the buffer of the non-AP MLD. This time limit is referred to the Delay Bound in the description.

This alternative applies onto the generic format 500 as illustrated by FIG. 5, but also to alternatives as the legacy buffer status as illustrated by FIG. 6a, and the 802.11ax buffer status as illustrated by FIG. 6b (and any of its variants).

The format 600c comprises a timing indication 620 is a time indication representative of a time limit for the transmission of the buffered data reported in the ML-BSR.

Thus, the non-AP MLD is now able to provide a ML-BSR indication linked with a related aging information, which can be seen as a validity duration for the reported amount of data.

The timing indication 620 may also be contemplated as the time limit for using indications reported within the ML-BSR. For example, whether the AP MLD notices that the time limit has expired, it may solicit again the non-AP MLD for a new ML-BSR.

In other words, the ML-BSR includes an amount of data, linked with a link identifier and a boundary timing, which results in an indication of said amount of data to be delivered under said given delay through a given link.

The delay bound is a current “live” information which helps the AP MLD for scheduling next communication slots. It shall be noted that neither the former EDCA nor the recent MU UL OFDMA can guarantee any throughput or delay bounds, but only performance differentiation among the categories.

The ML-BSR thus comprises a Delay Bound subfield 620. The ‘Delay Bound’ subfield is 1 octet in length and indicates the Delay Bound in Time Units (TUs, one TU equals to 1024 us), rounded down to the nearest TU, for the amount of buffered traffic to be transmitted as specified by Queue Size High subfield. The STA identified by the receiver address of the frame containing the ML-BSR Control subfield (e.g., AP) is expected to schedule frames buffered at station emitting the ML-BSR for delivery within the time period specified by this Delay Bound subfield and onto the specified link.

In variant, the Delay Bound can be expressed in form of a ‘Duration Units’ subfield and ‘Nominal Duration’ subfield, such that the expressed delay equals a number of Duration Units * Nominal Duration value.

For example:
the Duration Unit subfield is set to 0 if the unit is 256 us and is set to 1 if the unit is a TU. Additionally, value is set to 2 if the unit is expressed in multiple of TBTT (Target Beacon Transmission Time, indicated in beacon frame of the BSS). Another case could be a value 3 expressed in terms of TWT Wake Interval as negotiated in between the TWT non-AP MLD and the TWT AP MLD. These examples are not limitative.
The Nominal Duration subfield indicates the maximum amount of time, in the units indicated by the Duration Unit subfield, that the STA, i.e., the non-AP MLD, is expected to elapse from the transmission of the frame including the BSR until the next triggering frame, in order to complete transmission of buffered data specified in Queue Size subfield for the identified Traffic.

In the described alternatives (and associated embodiments) described in relation to FIGS. 6a, 6b and 6c, according to some embodiments, special values are reserved for the Link ID subfield and the amount of data subfield.

Thus, a Link ID subfield set to value ‘15’ may indicate that the reported amount of data is global, which is equivalent of the legacy BSR: the reporting station indicates no partial data amount has to be transmitted on a given Link, or the reporting station does not have that information.

When, for given TID and given Link ID, the amount of data field is set to value ‘0’, this aims at informing about the suspension of a link (Link suspension), in preference not closure. This is a special ML-BSR, which recommends to suspend any transmission on that link for given TID upon later notice.

According to some embodiments, the later notice being a ML-BSR with a positive value for amount of data for said Link and TID.

As explained hereinbefore, the ML-BSR according to the invention is used by a non-AP MLD in order to specify, for a given traffic, an indication relating to the amount of data contained in the buffer together with an indication relating to the link on which the non-AP is expected to be scheduled for said amount of data in the buffer.

In order to improve MU UL transmissions in the MLD context, it may also be contemplated to propose to improve the processing at the AP MLD side. Indeed, one angle of the technical problem is to ensure a low latency of the MU UL transmission.

The second aspect of the invention proposes to solve this technical problem using the fact that ML-BSR format is generic. According to a second aspect of the invention, the ML-BSR may be used by the AP MLD in order to indicate to a non-AP MLD, before actually transmitting the scheduling to the stations, on which link the upcoming UL transmission will occur together with the data to be transmitted during this UL transmission. Such a ML-BSR may be used in order to make an early announcement to the scheduled station regarding the resource allocation reserved by the AP for an upcoming UL trigger-based transmission. In order to help the station to prepare in advance the packet to be transmitted during this transmission opportunity, the ML-BSR further comprises the amount of data that such an allocated resource is able to convey.

This second aspect of the invention, may be considered independently from the first aspect. In this case, in the context of UL transmission, the AP MLD may send to the non-AP MLD a ML-BSR with an indication relating to the link on which the UL transmission will occurred together with data that may be transmitted using the indicated link.

As explained hereinbefore, the UL transmission may be either an UL MU transmission or a UL SU transmission. Therefore, according to transmission scheme, the ML-BSR may comprise different types of information: for example, for MU trigger-based transmissions, ML-BSR may further comprise information relating to the resource allocation, such as the link on which is the resource allocation to be used for the UL transmission.

Such scheme enables packets to be sent to be prepared in advance by the affiliated station of the non-AP MLD associated with the link indicated by the AP MLD. Therefore, such scheme enables to reduce the latency of the UL transmissions.

Indeed, as explained with reference to FIG. 2, the MLDs comprise a UMAC and a LMAC, specific to each link. Knowing in advance the link to be used for the upcoming scheduled transmission enables the preparing of the packet at the relevant LMAC associated to the link to be used.

According to some embodiments, such method enables the receiving non-AP MLD to prepare, before receiving the basic trigger frame for triggering the scheduled transmission, the data packet to be transmitted using the RU provided by the AP MLD and indicated in the ML-BSR.

Preparing the packets to be transmitted ahead the receiving of the trigger frame, enables the latency of the transmission to be reduced.

This second aspect of the invention may also be combined with the first aspect of the invention, such that the AP MLD uses a ML-BSR in a DL frame, before the trigger frame, in order to provide the non-AP MLD with information relating to the RU for the scheduled trigger-based transmission. The AP MLD determines the RU based on indications previously received from the non-AP MLD relating to, for a given traffic, information relating to the amount of data in the buffer awaiting to be transmitted and the link on which the non-AP MLD is expected to be scheduled for transmitting said data.

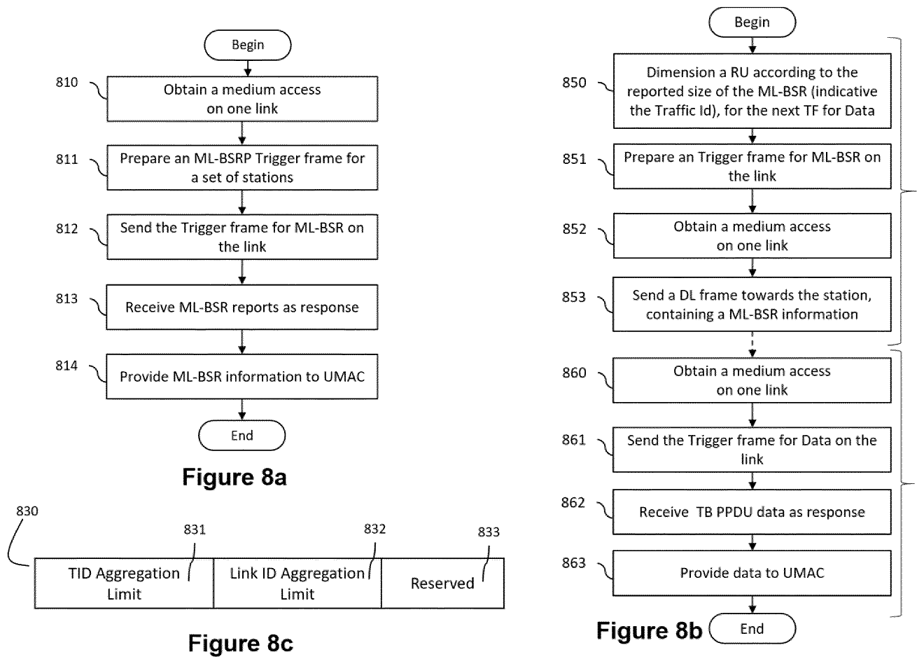

Such an embodiment is further detailed in the description of FIGS. 8a and 8b.

The second aspect of the invention intends to enhance the scheduling behaviour in a BSS administrated by an MLD AP of the invention, in order that such AP MLD could signal its next UL scheduling in advance to the corresponding UL transmission.

Through the usage of ML-BSR 500 inside DL MPDU frames, the AP MLD can advertise the further allocation for the non-AP MLD in advance to the effective UL transmissions.

This is advantageous for scheduled stations to be provided additional time for preparing the A-MPDU packet per link, that is to say in advance to the reception of the trigger frame or equivalent frame that requests the transmission of such A-MPDU packet.

The format of ML-BSR 500 is the same as the one described hereinbefore to be used by the non-AP MLD. Thus, the illustrated format in FIGS. 6a to 6c are suitable.

The difference is located in the meaning of the Amount of data, which is now an amount of data, corresponding to a given TID, to be allocated on a given link by next basic trigger frame for data transmission instead a report to a stored amount inside a transmit buffer or queue 332.

The AP MLD shall ensure that the amount of data indicated in the sent ML-BSR is correctly sized with regards to the subsequent effective allocations, and conversely.

For example, in the case of UL MU transmissions, the amount of data shall correspond to the subsequent allocated RU in the basic trigger frame. Indeed, the basic trigger frame comprises indications regarding the RU Length, RU Allocation and UL Modulation and Coding Scheme (MCS). The RU is sized in order to support the delivery of the indicated amount of data of AP's ML-BSR indication.

According to some embodiments, the ML-BSR sent by an AP MLD always contains significant values, otherwise not used.

According to some embodiments, the ML-BSR when emitted by an AP MLD may be considered to be a pre-trigger frame for configuring the next MU allocation.

According to some embodiments, the ML-BSR sent by an AP MLD takes the format of FIG. 6c, the timing indication 620 may also be contemplated as the time limit for been scheduled. For example, the non-AP MLD may use this indication as an information for power-saving activity on the given link (e.g., the non-AP MLD shall ensure that corresponding STA of a non-AP MLD is in active mode at the indicated timing).

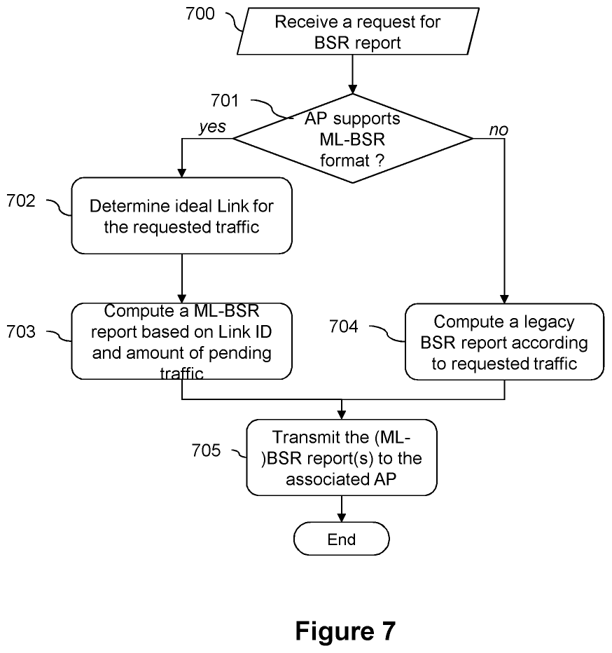

For better understanding, it is now referred to FIG. 7 illustrating, using a flowchart, the Multi-Link Buffer status report operation by a non-AP MLD or a non-AP station according to the invention.

The example tackles communication between a non-AP MLD and an AP MLD or AP station. To simplify the description, in the description hereinafter, it would be only referred to non-AP MLD and AP-MLD. Of course, the teaching, detailed hereinafter, may be easily applied to P2P communication.

Besides, the example tackles trigger-based UL MU transmissions. Of course, it may be adapted to UL SU transmission, for example using EDCA access: in this case, no TF is transmitted by the AP MLD, and the ML-BSR thus contains, further to the amount of data, the Link ID on which the non-AP MLD shall contend.

First, at step 700, the non-AP MLD receives from the AP MLD a request for a BSR report. This step is optional, as the non-AP MLD may transmit, in some embodiments, unsolicited ML-BSR.

Note that an AP according to embodiments of the invention may transmit a ML-BSRP Trigger frame that contains one or more RUs for random access.

Indeed, according to some embodiments, the ML-BSRP Trigger frame contains one or more RUs for random access to be used by the non-AP MLD for transmitting the BSR report.

Then, non-AP MLD, during step 701, determines whether the receiving AP MLD or station is able to handle the ML-BSR. Of course, the response is always positive if the non-AP MLD has received a request soliciting a ML-BSR.

In case of unsolicited report, the non-AP MLD may verify whether the AP MLD has indicated its support in the ML-BSR Support subfield of its EHT Capabilities element which are comprised in information obtained upon association procedure.

When the response is negative, that is to say that the AP is not able to handle such a ML-BSR, the station MLD then computes and transmits a legacy BSR (and not a ML-BSR) to the AP, at steps 704 and 705 respectively.

When the response is positive, the non-AP MLD first determines, at step 702, whether buffered data units are growing in its buffer. An amount of data and their aging may be determined at this step. Then, considering the amount of data awaiting to be sent, the non-AP MLD then determines which link or links are suitable, i.e., adapted, for the transmission of buffered data for a given traffic.

For example, considering the constraints of low latency delivery of real time flows, the non-AP MLD is then able to give an information relating to an immediate buffer queuing situation with regards to a given link. For example, it may happen that there is no possibility to access the medium. The determination may also be based on data rate of the available links: for example, a faster data rate or a larger bandwidth may influence the selecting of a given medium/link. The selecting may also depend on the interference on a given link make which may make it less suitable for data transmission.

Any implementation-specific scheduling algorithm may be envisaged.

At step 703, then the non-AP MLD prepares a ML-BSR, comprising an indication relating to the amount of data awaiting to be sent, for a give traffic, and an indication relating to the link or links on which the non-AP MLD expects to be scheduling for transmitting the determined amount of data. The ML-BSR may comprise additional information as detailed in the description of FIGS. 6a-6c.

At step 705, the non-AP MLD transmits the ML-BSR to the AP MLD, within a QoS Null, a QoS Data or in Management frames.

The station may aggregate several ML-BSRs (for example, one ML-BSR per aggregated QoS_Null frame) in order to report for several traffics, the amount of data awaiting to be sent together with the link(s) suitable for their transmission, as chosen by the non-AP MLD.

In that case, the steps 701-702-703 are repeated accordingly for each traffic or link to be reported.

FIG. 8a illustrates, using a flowchart, embodiments of the invention implemented at a scheduling station (AP MLD) when it solicits multi-link data reports (ML-BSR) according to embodiments of the invention.

First, at step 810, the AP MLD obtain a medium access on one link, in order to transmit, a trigger frame in order to solicit ML-BSR from the receiving non-AP MLD. The obtained link for medium access may be independent of the requested link or links for the triggered reports.

As explained, in relation to FIG. 7, the ML-BSR may be sent by the non-AP MLD either in response to a solicitation from the non-AP MLD.

As commonly known and explained hereinbefore, a TF solicits one or more HE/EHT Triggered-Based (TB) PPDU transmissions and allocates resources for these transmissions. In particular, the TF may also carry other information required by the responding STA to send an HE/EHT TB PPDU. The Trigger Type subfield identifies the TF variant.

Invention thus provides that a new Trigger Type subfield value is allocated for ML-BSR reports, to be used in the invention, according to some embodiments. For example, one value between 8-15, currently reserved by 802.11ax D8.0, is used as “Multi-link Buffer Status Report Poll (ML-BSRP)”.

According to some embodiments, the ML-BSRP has the same format as the BSRP Trigger frame. The difference lies on the different Trigger Type value that is used such that the ML-BSRP solicits a ML-BSR report.

According to some embodiments, in case that ML-BSR are transmitted within QoS Null frames, the AP shall indicate, in the ML-BSRP, a duration of the UL transmission from the non-AP MLD that enables the transmission of all QoS frames. For example, if three links are established between the non-AP MLD and the AP MLD according to the TID-to-link mapping, then the ML-BSRP comprises a UL length subfield, so that the HE TB PPDU Duration, i.e., the duration reserved for the transmission of ML-BSR for each links, fits the transmission of three QoS Null frames each comprising a ML-BSR report for a given link.

According to some embodiments, the ML-BSRP has the same format as the BSRP Trigger frame for the Common Info, except that either a ‘Trigger Dependent Common Info’ subfield and/or ‘Trigger Dependent User Info’ subfield may be added the ML-BSRP Trigger frame.

‘Trigger Dependent Common Info’ subfield and/or ‘Trigger Dependent User Info’ subfield are identical. For example, if a triggered station has no ‘Trigger Dependent User Info’ subfield in its ‘User Info’ subfield, the triggered station may inherit the parameters from the ‘Trigger Dependent Common Info’ subfield.

The ‘Trigger Dependent Common Info’ and ‘Trigger Dependent Common Info’ subfields are described in FIG. 8c.

First, the TID Aggregation Limit subfield 831 indicates the traffics that may be considered by the non-AP MLD in building a ML-BSR report. As example, the TID Aggregation Limit subfield 831 is of a bitmap format (2-byte length) wherein each bit set to 1 requests the corresponding indexed traffic or class to be reported in the ML-BSR.

For example:
Bits 0-7 are set for identifying a User Priority for either a Traffic Category (TC) or Traffic Stream (TS);
Bits 8-15 are set for identifying a TSID;
Bits 16-31 are set for identifying a SCSID (wherein the SCID value is determined by bit-masking with 0xF);
Bits 32-47 are set for identifying TWT Flow Identifier in the case that the low-latency traffic flow follows a TWT service period (wherein the TWT Flow ID value is determined by bit-masking with 0xF).

A value of 0xFF in the TID Aggregation Limit subfield 831 may indicate to the non-AP MLD that it may aggregate QoS Data frames in the multi-TID A-MPDU, regardless their TID values.

The Link ID Aggregation Limit subfield 832 indicates the link(s) that can be considered by the non-AP MLD when building a ML-BSR report. For example, it follows a bitmap format (1-byte length) wherein each bit set to 1 requests the corresponding indexed link to be reported.

According to some embodiments, a triggered station would only report links that are already setup, as indicating in the TID-to-Link mapping.

As a result, the AP may set the UL Length subfield of a ML-BSRP Trigger frame as the maximum number of links times the number of requested TIDs.

Thus, steps 810-811-812 illustrate an example of triggering a ML-BSR. At step 811, the AP thus prepares the ML-BSRP Trigger frame for a set of non-AP MLD. The preparing thus consists in, as detailed hereinafter, selecting the links and the TIDs to be considered by the stations when preparing the ML-BSR.

Thanks to the format illustrated in FIG. 8c, the AP may request global reports from globally all links and setup TIDs but also may request a single report about a given link and TID pair.

According to embodiments, the AP MLD may transmit a ML-BSRP Trigger frame that contains one or more RUs for random access, instead of, or in addition to, specifying dedicated stations or group of stations (e.g., BSSIDs).

Preferably, an AP that transmits a ML-BSRP Trigger frame shall set the CS Required subfield to 1. The CS Required subfield of the ML-BSRP is used to indicate whether the STAs identified in the User Info fields are required to use Energy Detection to sense the medium and to consider the medium state and the NAV in determining whether or not to respond. Then, at step 813, the AP receives ML-BSR reports in response to the ML-BSRP Trigger Frame.

The collected responses are further provided to the UMAC layer such that the AP MLD's scheduler may aggregate the buffer report indications and then may specify appropriate RU scheduling.

The scheduling by the AP MLD is now described with reference to FIG. 8b.

FIG. 8b illustrates, using a flowchart, an exemplary embodiment of the invention implemented at a scheduling AP MLD, after the AP MLD has received multi-link data reports (ML-BSR) and further intends to schedule at least one non-AP MLD according to embodiments of the invention.

The flowchart is a simple and non-limitative illustration of one usage of first informing a further allocation towards non-AP MLD(s) (steps 850 to 853), and secondly the real scheduled RU allocations (step 860 to 863). Any further adaptation or specific usage could be envisaged.

The format of ML-BSR 500 is flexible enough, such that a scheduling station (AP) can use the ML-BSR 500 for informing in advance the further scheduled RU resources.

Upon receiving at least one ML-BSR report from (at least one) non-AP MLD, the ML-BSR report being associated with a given traffic flow and a given link, at step 850, the AP MLD chooses the size of the RU according to the content of the ML-BSR.

Thus, ML-BSR indication received from a non-AP station are applied to the next scheduled transmission, for example before the next Service Period.

The RU scheduler of the AP MLD aims at determining the amount of resource allocation per link for each non-AP MLD, and then may prepare a trigger frame based on those determinations at step 851.

Any medium allocation by the AP may be considered to fulfill the expectation of the non-AP MLD (e.g., a distinct SU communication initiated by the AP, a further MU scheduling based on ML-BSR, etc.).

Then, the AP MLD transmits to the non-AP MLD a subsequent frame comprising scheduling information relating to the UL transmission of the amount of data to be transmitted (reported in the ML-BSR received at step 813).

According to some embodiments, the subsequent frame is a DL frame sent before the TF for triggering the transmission of reported amount of data in the received ML-BSR. The DL may comprise an element with the same format as ML-BSR, indicating the resource allocation for a given traffic.

The subsequent frame may be, according to some embodiments, the TF (e.g., with the ‘Basic’ type) triggering the UL MU transmission of the amount of data identified in the received in ML-BSR.

The scheduling information may comprise indication relating the resource allocation for the UL transmission of the reported amount of data in the previously received ML-BSR. For example, the resource allocation may be related to a link to be used.

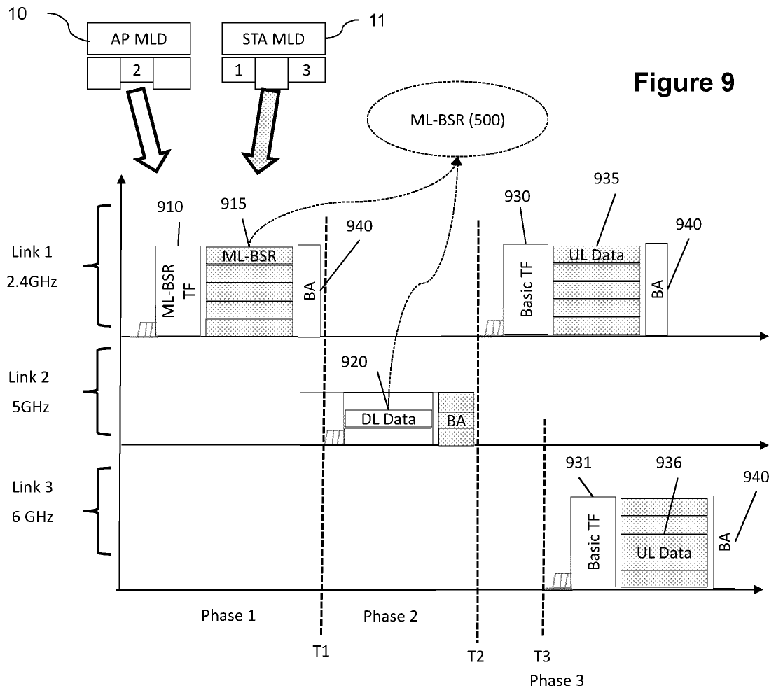

According to some embodiments, the TF use for triggering transmission of non-AP MLD and including information relating to RU allocation is performed in a granted TXOP that is different to the TXOP one used to send a preceding ML-BSR indication to the non-AP station. This embodiment is illustrated in FIG. 9, by the way.

The preceding ML-BSR is thus sent by the AP MLD, before the TXOP during which the non-AP is scheduled, such that the non-AP MLD may prepare, ahead of schedule, data to be sent.

The steps 852 to 853 are optional, as the RU allocation is provided within the TF. The RU is sized accordingly to the resource allocation provided to the non-AP MLD.

These steps are recommended as they provide information in advance to the scheduled station(s) so they may have a ready TB PPDU frame to be transmitted, before receiving the TF on a concerned link.

The steps 860 to 863 are classical steps for scheduling transmission of MU resources and obtaining TB PPDU responses.

By adopting such a dynamical reporting by stations according to embodiments of the invention, the resource unit allocation is more efficient for fluctuant traffic over links. The allocation of wireless resources (links) by the AP MLD is performed in regards to the real expectations and needs of scheduled non-AP MLD. In addition, scheduled non-AP MLD may be aware in advance of the next scheduling, which is beneficial to reduce contention by those scheduled stations on the concerned link or other links as fallback.

In order to perfectly understand the sequencing of the different steps described hereinbefore with reference to the FIGS. 7, 8a and 8b, an exemplary timeline of a communication exchange according to embodiments of present invention, as illustrated in FIG. 9.

In this exemplary scenario, an AP MLD 10 has pending data to be delivered towards a non-AP MLD 11 via link 2. The non-AP MLD 11 has pending data intended to the AP, which could be delivered using the links 1 and 3.

In a first phase, the AP MLD collects the overall BSR needs from a set of stations, including the non-AP MLD 11, using a ML-BSRP Trigger Frame 910. Then, the non-AP MLD 11 responds with a QoS_Null frame including a ML-BSR1 915. As explained before, the ML-BSR1 915 comprises an indication relating to the amount of data awaiting to be transmitted for a given traffic and an indication relating to the links 1 and 3 the non-AP MLD 11 expects to use for transmitting these data. Of course, in the event where data awaiting to be sent is to be reported for other traffics, other QoS_Null frames including ML-BSRs may be sent for each traffic.

The first phase corresponds to the algorithms illustrated in FIGS. 8a and 7, respectively performed at AP MLD 10 and the non-AP MLD 11.

Next, in phase 2, the AP MLD determines the allocations for further MU communications, considering the received ML-BSR. The AP MLD then may indicate those allocations through any transmission means.

As the AP MLD has pending data, it may use link 2 to send those data to the non-AP MLD: the AP MLD inserts a ML-BSR inside the MAC header of at least one MAC data frame format the DL communication to the non-AP ML station.

For example, a MU DL PPDU communication may be used by the non-AP MLD wherein the DL RU are addressed to each non-AP MLD concerned by the further UL scheduling, or indifferently a SU PPDU, possibly unicast or broadcast.

Alternatively, for example, in the case that the AP MLD has no data to transmit within a DL transmission to a given subsequent scheduled STA, the AP MLD may use a QoS_Null data frame to support the transmission of ML-BSR scheduling indications.

Thus, the second phase corresponds to the described steps 852 to 853 of algorithms 8b performed at the non-AP MLD.

By the way, in the illustrated timeline, the RU indications addressed to non-AP MLD 11 in the MU DL PPDU 920 contains two ML-BSR reports, a first one indicating of a first quantity of data to be scheduled on the link 1 for a given TID, and a second one indicating of a second quantity of data to be scheduled on the link 3 for a given, possibly different or not, TID.

Then, before phase 3, the non-AP MLD is aware of the subsequent scheduling on each link. Therefore, the non-AP MLD may be prepared at the UMAC layer the PPDUs to be deliver on each links, 1 and 3.

The UL Data is ready to be sent by non-AP MLD upon reception of a TF 930 and 931 for triggering the MU UL transmission respectively on links 1 and 3.

Hopefully, depending on any scheduling consideration or choice performed by AP MLD, the allocations correspond to the requested resource that the non-AP MLD have indicated during phase 1.

Phase 3 corresponds to steps 860 to 863 of algorithms 8b perform at AP MLD 10.

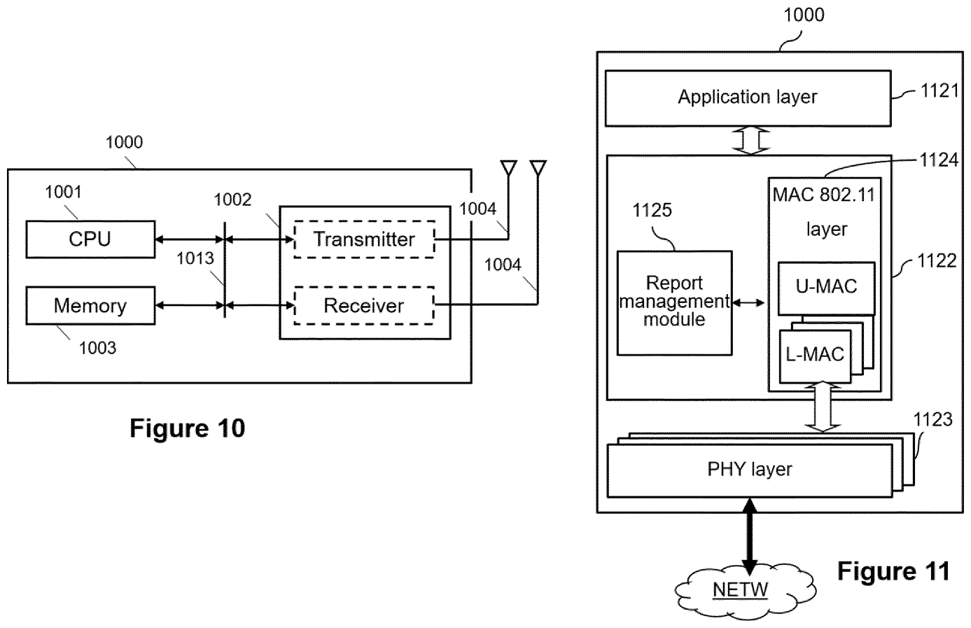

FIG. 10 schematically illustrates a communication device 1000, either a non-AP MLD, embedding a plurality of non-AP stations 110, or an AP MLD, embedding a plurality of APs 100, of a radio network NETW, configured to implement at least one embodiment of the present invention. The communication device 1000 may preferably be a device such as a micro-computer, a workstation or a light portable device. The communication device 1000 comprises a communication bus 1013 to which there are preferably connected:
a central processing unit 1001, such as a processor, denoted CPU;
a memory 1003 for storing an executable code of methods or steps of the methods according to embodiments of the invention as well as the registers adapted to record variables and parameters necessary for implementing the methods; and at least one communication interface 1002 connected to a wireless communication network, for example a communication network according to one of the IEEE 802.11 family of standards, via transmitting and receiving antennas 1004.

Preferably the communication bus provides communication and interoperability between the various elements included in the communication device 1000 or connected to it. The representation of the bus is not limiting and in particular the central processing unit is operable to communicate instructions to any element of the communication device 1000 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002, in order to be stored in the memory of the communication device 1000 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 11 is a block diagram schematically illustrating the architecture of the communication device 1000, adapted to carry out, at least partially, the invention. As illustrated, device 1000 comprises a physical (PHY) layer block 1123, a MAC layer block 1122, and an application layer block 1121.

The PHY layer block 1123 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1122 preferably comprises a MLE MAC 802.11 layer 1124 implementing conventional 802.11 MAC operations, and additional block 1125 for carrying out, at least partially, embodiments of the invention. The MAC layer block 1222 may optionally be implemented in software, which software is loaded into RAM 1003 and executed by CPU 1001. The MLE MAC 802.11 layer 1124 may implement an Upper-MAC stack 230 along with a series of Lower-MAC modules 220-x/z.

Preferably, the additional block 1125, referred to as Report management module for performing low-latency service over multi-link communications, implements part of embodiments of the invention (either from station, non-AP MLD, perspective or from AP, AP MLD, perspective). This block performs the operations of FIG. 7 or 8a and 8b, depending on the role of the communication device 1000, non-AP or AP MLD.

MAC 802.11 layer 1124 and Report management module 1125 interact one with the other in order to establish and process accurately communications over OFDMA RU in between multiple ML non-AP stations according to embodiments of the invention.

On top of the FIG. 11, application layer block 1121 runs an application that generates and receives data packets, for example data packets such as a video stream. Application layer block 1121 represents all the stack layers above MAC layer according to ISO standardization.

Among MLDs, there exists some MLDs that experience Non-Simultaneous Transmit And Receive (NSTR) pairs of communication links. A NSTR links pair is made of two communication links on which simultaneous transmissions cannot occur. In other words, a links pair is indicated as having a non-simultaneous transmit and receive relationship between its communication links. One or more links pair can be NSTR within the same MLD, be it an AP MLD or a non-AP MLD.

For example, in the context illustrated in FIG. 1, the non-AP MLD 11 may experience NSTR operation if the non-AP MLD 11 indicates that it cannot simultaneously receive and transmit on the communication links 15-x and 15-y. Note that the following description considers that an AP MLD has only Simultaneous Transmit And Receive (STR) links pairs, but in other embodiments (not described here) the AP may experience NSTR operations.

As result, when a non-AP MLD transmits on one link of a NSTR links pair, the STA related to the other link of the NSTR links pair can lose its medium synchronization.

For example, in the context of FIG. 1, a transmission occurring on link 15-y may prevent non-AP STA 110-x related to the other link 15-x of the NSTR links pair, to determine the status of link 15-y, hence to keep synchronization.

One way to avoid precited issues, is to use the AP assistance, as the AP MLD (i.e. affiliated APs) has a global view of the status of the communication links at any time.

The AP Assistance Request (AAR) mechanism, introduced in 802.11be D1.0, proposes to a STA of an NSTR links pair to solicit the AP MLD for an uplink transmission usually on the other link of the NSTR links pair.

The AAR mechanism (hence solicitation) is signalled in HT/HE/EHT Control subfield 413 of the MAC frame using a new type of Control field 450 (called “AP Assistance Request”) made of a Control ID subfield 415 set to 10 and a Control Information subfield 452 which indicates the link identifier of another AP affiliated with the same AP MLD to solicit this other AP to transmit a Trigger frame.

The indication of the link identifier may be performed using a Link Bitmap, for example using a so-called Assisted AP Link ID Bitmap subfield as defined in the 802.11be D1.0 standard, indicating the link or links associated with the solicited affiliated AP of the AP MLD.

As defined in the standard, the Assisted AP Link ID Bitmap subfield indicates the link identifier(s) of an AP affiliated with an AP MLD that is solicited to transmit a Trigger frame to a non-AP STA affiliated with a non-AP MLD that belongs to a NSTR link pair after a frame that contains AAR Control subfield sent by another non-AP STA affiliated with the same non-AP MLD to its associated AP affiliated with the same AP MLD.

The Link Bitmap is used as follows: a value of 1 in bit position i of the Assisted AP Link ID Bitmap subfield means that the link ID i is the link identifier of the solicited AP affiliated with the AP MLD; a value of 0 in bit position i of the Assisted AP Link ID Bitmap subfield means that the link ID i is not the link identifier of the solicited AP affiliated with the AP MLD.

Although the AP MLD may have knowledge of the overall transmission needs of the non-AP MLDs, it still does not know their needs per links. Hence, the AAR mechanism which triggers MU UL transmissions for the non-AP MLDs cannot size correctly the resource units to be provided per non-AP MLD on each link.

The scheduling using AAR mechanism may thus be improved because, as explained in relation with the first aspect of the invention, the AP MLD may not be aware of local disturbances at the non-AP MLD side.

In order to enable the AP MLD to have more complete information relating to the links when scheduling UL transmission, a third aspect of the invention proposes to supplement the AAR mechanism for scheduling UL transmission, with BSRs to report transmission needs on a link basis. This therefore implements ML-BSRs to report the amount of data the non-AP MLD expects to transmit using each link.

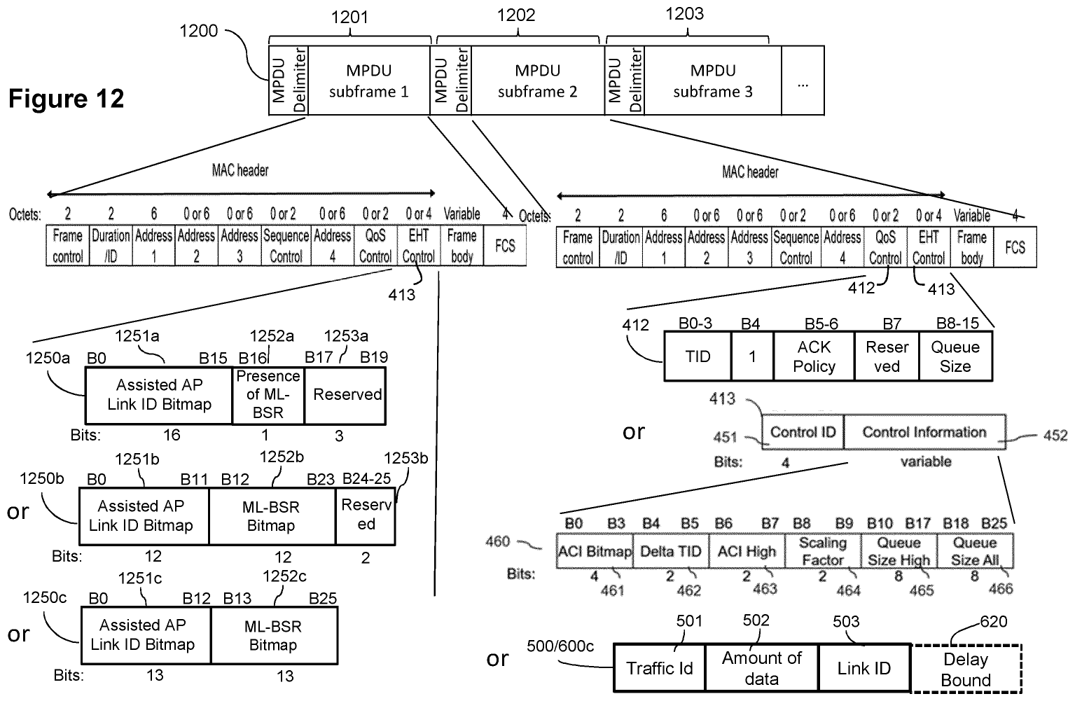

Such improvements are now illustrated with the embodiments described in relation with FIG. 12. These embodiments provide sending a Link Bitmap indicating one or more links for which an amount of data to be transmitted is provided. The amounts of data may be provided using ML-BSRs as introduced above or legacy BSRs (460 in FIG. 4). Hence, one ML-BSR or legacy BSR can be provided for each link indicated in the Link Bitmap. Therefore, a Link Bitmap may be sent in advance to a series of ML-BSRs or BSRs related to the links indicated in the Link Bitmap. To facilitate the parsing, the ML-BSRs or legacy BSRs can be provided, after the Link Bitmap, in the same order as the link declarations within the Link Bitmap.

It is referred to “global report” or “global ML-BSR” to designate the Link Bitmap and the one or more ML-BSRs or BSRs that follow.

For the sake of illustration, the embodiments are described within the AP Assistance Request (AAR) mechanism (to solicit uplink transmission) according to 802.11be draft D1.0.

Of course, the use of the Assisted AP Link ID Bitmap is not mandatory, and one may contemplate using any other Link Bitmap (isolated from the Assisted AP Link ID Bitmap) indicative of at least one link in this embodiment. Besides, any bitmap size different from 16 bits (as defined for the AAR) may also be considered.

In the illustrated example the global report may be split over an aggregation frame, such as an A-MPDU 1200, comprising an initial MPDU subframe 1201, including the Link Bitmap, and subsequent MPDUs 1202, 1203 including the reported amount of data per link (through ML-BSRs or legacy BSRs) for the links indicated within the Link Bitmap. For example, the non-AP MLD delivers a series of aggregated MPDUs (A-MPDU) 1200, each MPDU inside a MPDU subframe separated from the other by a MPDU delimiter according to the conventional 802.11 A-MPDU aggregation scheme.

The initial A-MPDU subframe 1201 contains the Link Bitmap information relating to the link for which an amount of data to be transmitted is provided, hence a ML-BSR is provided.

Three formats for providing the Link Bitmap information are illustrated on FIG. 12.

The first format 1250a is based on the legacy format of the AAR Control field provided in the 802.11be D1.0 standard (within Control field 413).

The AAR control field 413 comprises a Control ID 451/651 (not represented) and a Control Information subfield 1250a. The latter is modified compared to 802.11be D1.0, to include the legacy Assisted AP Link ID Bitmap subfield 1251a, a ML-BSR presence subfield 1252a and possible Reserved subfield 1253 (e.g., 3 bits).

The Assisted AP Link ID Bitmap subfield 1251a is used in a conventional manner: value 1 in bit position i to signal link ID i; value 0 not to signal link ID i. For example, the Assisted AP Link ID Bitmap field may be of 16 bits.

ML-BSR presence subfield 1252a may be a one-bit field, indicating whether an amount of data to be transmitted is provided per link. For example, when field 1252a is set to ‘0’, the per-link amounts of data to be transmitted are subsequently provided for the links indicated in the Assisted AP Link ID Bitmap 1252a.

In that case, the per-link bit in the Assisted AP Link ID Bitmap 1251a may constitute the link indication to form, together with the declared amount of data, a ML-BSR.

According to some embodiments, the Control ID field 451 may be set to ‘10’ in order to signal the AAR Control field 413, including the Control Information 1250a field.

Alternatively to the illustration wherein the bit B16 embeds the subfield 1252a, any one bit of the Reserved bits B16 to B19 of the legacy AAR control format may be used as an indication of the specific version/format of AAR Control field 1250a.

The second format comprises a new Control Information field 1250b using the maximum size (26 bits) allowed for a Control field 450. The Control Information field 1250b comprises an Assisted AP Link ID Bitmap subfield 1251b, a ML-BSR Bitmap subfield 1252b and possible Reserved subfield 1253b. In this format, the Assisted AP Link ID Bitmap 1251b has a reduced length compared to the legacy Assisted AP Link ID Bitmap 1251a (16 bits). The Assisted AP Link Bitmap subfield 1251b shown in the Figure is made of 12 bits. Of course, any other length may be used.

The second field, the ML-BSR Bitmap subfield 1252b, is a set of bits dedicated to the same links as the one indicated in the Assisted AP Link ID Bitmap subfield 1251b forming the Link Bitmap according to the invention, here referred to as “ML-BSR bitmap”.

Such a format 1250b provides the advantage of specifying which links are involved in the global report, i.e., for which links ML-BSRs and/or BSRs will be subsequently provided.

As a result, the ML-BSR Bitmap subfield 1252b indicates the identifiers of the links of affiliated APs for which an uplink trigger-based transmission is solicited and related to a subsequent ML-BSR or a subsequent BSR.

According to some embodiments, the ML-BSR Bitmap 1252b has the same length as the Assisted AP Link ID Bitmap 1251b (e.g., 12 bits). Similar to the Assisted AP Link ID Bitmap 1251b, value 1 in bit at position i in the ML-BSR Bitmap 1252b indicates that an amount of data to be transmitted is subsequently provided for link ID i.

According to some embodiments, the ML-BSR Bitmap subfield 1252b fits within the Assisted AP Link ID Bitmap 1251b; that is to say that the set of links identified by the ML-BSR Bitmap subfield 1252b is a subset of the set of links identified by the Assisted AP Link ID Bitmap 1251b. In an alternative without such a limitation, the ML-BSR Bitmap subfield 1252b specifies transmission needs for links independently to the links considered for the AAR request (in the Assisted AP Link ID Bitmap 1251b). This is advantageously more informative about resource allocation needs, in complement to the set of links used in AP Assistance Request mechanism.

According to some embodiments, the Control ID field 451 (not represented) may be set to ‘11’ in order to signal this format for the AAR Control field 413, i.e., including Control Information field 1250b.

Alternatively (i.e., conventional value ‘10’ is still used for Control ID field 451), one bit of the Reserved field 1253b (e.g., 2 bits) may be used as an indication of the specific version/format of AAR Control field 1250b.

The third format comprises a new Control Information field 1250c still using the maximum size (26 bits) allowed for a Control field 450. Compared to the second format, no bits are reserved. Hence, the Control Information field 1250c is made of an Assisted AP Link ID Bitmap subfield 1251c and a ML-BSR Bitmap subfield 1252c. In this format, the Assisted AP Link ID Bitmap 1251c has a reduced length compared to the legacy Assisted AP Link ID Bitmap 1251a (16 bits). The Assisted AP Link Bitmap subfield 1251b shown in the Figure is made of 13 bits. Of course, any other length may be used, e.g., when the new Control Information field 1250c uses less than 26 bits.

The format 1250 of the AAR Control Information subfield 413 is different from the ones previously presented (1250a, 1250b), as it comprises only two subfields, one being dedicated to the Assisted AP Link ID Bitmap 1251c (e.g., 13-bit long) and the other being dedicated to the ML-BSR Bitmap 1252c (e.g., of the same length).

In this case, the two bitmaps, Assisted AP Link ID Bitmap 1251c and ML-BSR Bitmap 1252c, fulfill the maximum limit of 26 bits for a Control Information field 452.

According to some embodiments, a special value for the Control ID subfield 451 may be contemplated in order to indicate that the format 1250c should be considered (e.g., 11 or 12). The Assisted AP Link ID Bitmap 1251c and ML-BSR Bitmap 1252c may be used in a similar manner as for the second format above.

The Link Bitmap, either Assisted AP Link ID Bitmap 1251a or ML-BSR Bitmap 1252b or 1252c, therefore indicates the links for which an amount of data to be transmitted is subsequently provided, i.e., for which the per-link transmission needs are declared.

Turning now to the signaling of such per-link amounts of data to be transmitted, ML-BSRs or legacy BSRs are transmitted subsequently to the Link Bitmap for the links identified in the Link Bitmap. The ML-BSRs or legacy BSRs are transmitted in one or more MPDU subframes 1202, 1203 aggregated with the MPDU subframe 1201 carrying the Link Bitmap.

According to some embodiments, the number of bits set to ‘1’ in the Link Bitmap indicates the number of following ML-BSRs or legacy BSRs. In some embodiments, multiple ML-BSRs or legacy BSRs can be included in one and the same MPDU subframe. In other embodiments, one ML-BSR or legacy BSR is provided per subsequent MPDU aggregated in the A-MPDU frame 1200. The following one or more MPDU subframes 1202, 1203 thus contains the ML-BSRs and/or BSRs for each link indicated in the Link Bitmap.

As shown at the bottom-right side of FIG. 12, the per-link amount of data to be transmitted may be declared using a ML-BSR according to the embodiments (or combination thereof) described above with reference to FIGS. 5, 6a, 6b and 6c.

In variant illustrated through reference 460 in FIG. 12, the per-link amount of data to be transmitted may be declared using a legacy BSR according to FIG. 4.

In yet another variant illustrated through reference 412 in FIG. 12, the per-link amount of data to be transmitted may be declared using the QoS Control field 412 of a subsequent MPDU frame 1202, 1203.

As the legacy format 412 (inside QoS Control field) and the 802.11ax BSR format 460 (inside the HT/HE/EHT Control field 413) do not carry a field to specify the link concerned, they are provided in the same order as the link indications in the Link Bitmap. This allows the AP to associate each BSR with the appropriate link.

Therefore, the legacy format 412 and the 802.11ax BSR format 460 are well adapted to provide an amount of buffered data for a given TID that is to be scheduled for a given link (as defined in the Link Bitmap).

The format of a BSR control field 460 may be preferred as it provides more information on the pending amount of data per TID.

In these embodiments (412 and 460), the per-link bit in the Link Bitmap is the indication in the meaning of the invention, i.e., relating to a link on which the station MLD expects to be scheduled for the transmission of the amount of data to be transmitted. The ML-BSR for a given link is therefore made of the corresponding link in the Link Bitmap plus the BSR (412 or 460) subsequently provided.

Back to the ML-BSR 500/600c variant, the ML-BSRs may be advantageously provided in any order throughout the subsequent MPDU subframes 1202, 1203, because they directly include the indication relating to the concerned link.

BSRs (412 or 460) and ML-BSRs may be mixed, in which case their order should be preferably the one of the link declaration within the Link Bitmap.

In the embodiments described with reference to FIG. 12, the Link Bitmap (1251a, 1252b or 1252c) indicates the link identifier(s) for which the reporting station indicates an amount and type (TID) of buffered data traffic in the subsequent MPDU subframes, using BSRs and/or ML-BSRs. The station identified by the receiver address of the frame containing the ML-BSR Control subfield (e.g., AP MLD) is expected to trigger uplink transmissions on the links identified in the Link Bitmap at station which has provided BSRs or ML-BSRs.

Independently to the use of BSR or ML-BSR, one MPDU subframe 1302, 1303 (subsequent to the initial MPDU 1201) may contain the declared amount of buffered data for one link, i.e., related to one bit set to ‘1’ in the Link Bitmap.

According to some embodiments, the first MPDU 1201 contains a QoS Control field 412, wherein the Queue Size information 403 indicates the global amount of all pending data at the non-AP MLD.

According to some embodiments, in order to make the resulting AAR request frame lighter, QoS_Null frame may be aggregated inside the A-MPDU 1200 (that means the MPDU subframes 1201 and following ones have no frame body).

The described examples are based on several aggregated MPDU frames, as the typical locations of AAR information and BSR information are inside the header of MAC frames, notably in the HT/HE/EHT Control field 413 having a length limited (26-bits).

Of course, according to other embodiments, it may be contemplated to provide a single MAC frame incorporating the numerous fields (corresponding to AAR, BSR information) inside its frame body. The size limitation of the Control field 413 to 26-bits may be overcome by specifying a new frame type for easily identifying this new frame format. As a result, multiple ML-BSRs may be provided within the same HT/HE/EHT Control field 413.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method in a wireless communication network comprising an access point, (AP), multi-link device, (MLD), having multiple affiliated access points, and a station MLD, having multiple affiliated stations, both station MLD and AP MLD being able to exchange data using one or more links,
the method comprising at the station MLD:
transmitting to the AP MLD a multi-link buffer status report; (ML-BSR); comprising information relating to an amount of data to be transmitted, for the AP MLD to schedule a resource to the station MLD to transmit data; and
wherein the ML-BSR further comprises information relating to a link on which the resource is expected to be scheduled to the station MLD for the transmission of the amount of data to be transmitted.

2. The method of claim 1, wherein the method further comprises:
receiving from the AP MLD scheduling information for the transmission of the amount of data to be transmitted; and
transmitting the amount of data to be transmitted according to the received scheduling information.

3. The method of claim 136, wherein the ML-BSR comprises a first field comprising information relating to the amount of data in a buffer of the station MLD, a second field comprising information relating to the link on which the resource is expected to be scheduled to the station MLD for the transmission of the amount of data to be transmitted, and a third field comprising information reporting the type of data.

4-6. (canceled)

7. The method of claim 1, wherein the method comprises at the station MLD:
sending a link bitmap indicating one or more links for which an amount of data to be transmitted is provided.

8-9. (canceled)

10. The method of claim 1, wherein the transmission of the ML-BSR is in response to a receiving of a request to provide information relating to an amount of data to be transmitted by the station MLD for a given type of data and information relating to a link on which the resource is expected to be scheduled to the station MLD for the transmission of the amount of data to be transmitted,
wherein the request is from the AP MLD.

11. The method of claim 1, wherein the ML-BSR is transmitted using a link different from the link indicated within the ML-BSR.

12. A communication method in a wireless communication network comprising an access point (AP) multi-link device (MLD) having multiple affiliated access points and a station MLD, having multiple affiliated stations, both station MLD and AP MLD being able to exchange data using one or more links,
the method comprising at the AP MLD:
receiving from the station MLD, a multi-link buffer status report ML-BSR, comprising information relating to an amount of data to be transmitted, for determining scheduling resource for the station MLD to transmit data, wherein the ML-BSR further comprises information relating to a link on which the resource is expected to be scheduled to the station MLD for a transmission of the amount of data to be transmitted.

13. The method of claim 12, wherein the method further comprises:
according to the received ML-BSR, determining scheduling information to be used by the station MLD for the transmission of the amount of data to be transmitted; and
transmitting to the station MLD, within a subsequent frame, the determined scheduling information.

14-15. (canceled)

16. The method of claim 12, wherein the method comprises:
receiving a link bitmap indicating one or more links for which an amount of data to be transmitted is provided.

17. (canceled)

18. The method of claim 12, wherein the receiving is in response to a sending of a request to provide information relating to the amount of data to be transmitted by the station MLD and relating to the link on which the resource is expected to be scheduled to the station MLD for the transmission of the amount of data to be transmitted.

19-20. (canceled)

21. A communication method in a wireless communication network comprising an access point (AP) multi-link device (MLD) having multiple affiliated access points and a station MLD, having multiple affiliated stations, both station MLD and AP MLD being able to exchange data using one or more links,
the method comprising at the AP MLD:
transmitting to the station MLD a multi-link buffer status report (ML-BSR), informing about a determined link and comprising information relating to a resource allocation on the determined link to be used for a subsequent uplink transmission, and information relating to an amount of data that the allocated resource is capable to convey.

22. The communication method of claim 21, wherein the ML-BSR is comprised within a downlink MAC frame.

23. An access point (AP) multi-link device (MLD) having multiple affiliated access points in a wireless communication network comprising a station MLD, having multiple affiliated stations, both station MLD and AP MLD being able to exchange data using one or more links, and
the AP MLD comprising a microprocessor configured to perform:
receiving from the station MLD, a multi-link buffer status report, (ML-BSR) comprising information relating to an amount of data to be transmitted, for determining scheduling resource for the station MLD to transmit data, wherein the ML-BSR further comprises information relating to a link on which the resource is expected to be scheduled to the station MLD for a transmission of the amount of data to be transmitted.

24. An access point (AP) multi-link device (MLD) having multiple affiliated access points, in a wireless communication network comprising an MLD, having multiple affiliated stations, both station MLD and AP MLD being able to exchange data using one or more links, and
the AP MLD comprising a microprocessor configured to perform:
transmitting to the station MLD a multi-link buffer status report (ML-BSR), informing about a determined link and comprising information relating to a resource allocation on the determined link to be used for a subsequent uplink transmission, and information relating to an amount of data that the allocated resource is capable to convey.

25. A station multi-link device (MLD) having multiple affiliated stations in a wireless communication network comprising an access point (AP) multi-link device (MLD) having multiple affiliated access points, both station MLD and AP MLD being able to exchange data using one or more links, and
the station MLD comprising a microprocessor configured to perform:
transmitting to the AP MLD a multi-link buffer status report (ML-BSR) comprising information relating to an amount of data to be transmitted, for the AP MLD to schedule a resource to the station MLD to transmit data; and
wherein the ML-BSR further comprises information relating to a link on which the resource is expected to be scheduled to the station MLD for the transmission of the amount of data to be transmitted.

26. A computer-readable storage medium storing instructions of a computer program for implementing a method according to claim 1.

27. A method comprising generating and sending a frame to be sent by a station multi-link device (MLD) having multiple affiliated stations to an access point (AP) multi-link device (MLD) having multiple affiliated access points of a wireless communication network, the frame comprising information relating to an amount of data awaiting to be sent by the station MLD,
wherein the frame further comprises information relating to a link on which the resource is expected to be scheduled to the station MLD for the trigger-based uplink transmission.

28-35. (canceled)

36. The method of claim 1, wherein the ML-BSR further comprises an information reporting a type of data which is associated with the amount of data to be transmitted.

37. The method of claim 1, wherein the station MLD is a non-AP MLD, whose affiliated stations are non-AP stations.

38. The method of claim 1, wherein the station MLD is an AP MLD, whose affiliated stations are AP stations.

39. The method of claim 1, wherein the station MLD is a non-AP MLD, whose affiliated stations are non-AP stations, and wherein the AP MLD is a software AP supporting Wi-Fi Direct protocol.
